(19) United States
(12) Patent Application Publication
(10) Pub. No.: US 2026/0084713 A1
(43) Pub. Date: Mar. 26, 2026

(54) CONTEXT-AWARE MANEUVER SHARING AND COORDINATION

(71) Applicant: QUALCOMM Incorporated, San Diego, CA (US)

(72) Inventors: Mohammad NEKOUI, Escondido, CA (US); Soumya DAS, San Diego, CA (US)

(21) Appl. No.: 18/890,982

(22) Filed: Sep. 20, 2024

(51) Int. Cl. B60W 60/00; G08G 1/0967; G08G 1/16; H04W 4/46

(52) U.S. Cl. CPC B60W 60/001; G08G 1/096791; G08G 1/161; H04W 4/46

(57) ABSTRACT

Disclosed are techniques for driver assistance or automated driving technologies. In an aspect, a processing device of a remote vehicle (RV) may receive a maneuver request message from a host vehicle (HV), the maneuver request message indicating a requested maneuver of the HV and driving context information of the HV, where the driving context information includes one or more characteristics of operating the HV. The processing device may obtain a determination result by determining whether the requested maneuver of the HV is accepted or rejected based on a planned maneuver of the RV, the requested maneuver of the HV, and the driving context information of the HV. The processing device may transmit a maneuver response message indicating the requested maneuver of the HV being accepted or rejected by the RV based on the determination result.

### TECHNICAL FIELD

Aspects of the disclosure relate generally to driver assistance or automated driving technologies.

### BACKGROUND

Modern motor vehicles are increasingly incorporating technology that helps drivers to obtain a planned route for navigation from a current location to a destination (e.g., an automotive navigation system), to avoid drifting into adjacent lanes or making unsafe lane changes (e.g., lane departure warning (LDW)), to be warned about the presence of another vehicle behind a current vehicle when backing up, or to be assisted with automatic braking if another vehicle ahead of the current vehicle stops or slows suddenly (e.g., forward collision warning (FCW)), among other things. The continuing evolution of automotive technology aims to deliver even greater safety benefits, and ultimately deliver automated driving systems (ADS) that can handle the entire task of driving without the need for user intervention.

There are six levels of driving automation that have been defined to achieve full automation. At Level 0, the human driver does all the driving. At Level 1, an advanced driver assistance system (ADAS) on the vehicle can sometimes assist the human driver with either steering or braking/accelerating, but not both simultaneously. At Level 2, an ADAS on the vehicle can itself actually control both steering and braking/accelerating simultaneously under some circumstances. The human driver must continue to pay full attention at all times and perform the remainder of the driving tasks. At Level 3, an ADS on the vehicle can itself perform all aspects of the driving task under some circumstances. In those circumstances, the human driver must be ready to take back control at any time when the ADS requests the human driver to do so. In all other circumstances, the human driver performs the driving task. At Level 4, an ADS on the vehicle can itself perform all driving tasks and monitor the driving environment, essentially doing all of the driving, in certain circumstances. The human driver or occupants need not pay attention in those circumstances. At Level 5, an ADS on the vehicle can do all the driving in all circumstances. The human occupants are just passengers and need never be involved in driving.

In some applications, an ADAS or an ADS on a host vehicle may rely on local sensors and a motion planning module to independently decide whether to instigate a lane change or merge maneuver, sometimes without assistance from the neighboring vehicles. In some applications, such independent decision-making schemes may impose safety concerns with respect to increasing the chance of collision between the host vehicle and the neighboring vehicles, or limiting the time the neighboring vehicles may safely response to the lane change or merge maneuver executed by the host vehicle.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of maneuver sharing and coordination performed by a processing device of a remote vehicle (RV) includes receiving a maneuver request message from a host vehicle (HV), the maneuver request message indicating a requested maneuver of the HV and driving context information of the HV, wherein the driving context information includes one or more characteristics of operating the HV; obtaining a determination result by determining whether the requested maneuver of the HV is accepted or rejected based on a planned maneuver of the RV, the requested maneuver of the HV, and the driving context information of the HV; and transmitting a maneuver response message indicating the requested maneuver of the HV being accepted or rejected by the RV based on the determination result.

In an aspect, a method of maneuver sharing and coordination performed by a processing device of a host vehicle (HV) includes transmitting a maneuver request message to one or more remote vehicles (RVs), the maneuver request message indicating a requested maneuver of the HV and driving context information of the HV, wherein the driving context information includes one or more characteristics of operating the HV; and receiving one or more maneuver response messages from the one or more RVs, the one or more maneuver response messages indicating the requested maneuver of the HV indicated by the maneuver request message being accepted or rejected by the one or more RVs.

In an aspect, a processing device of a remote vehicle (RV) includes one or more memories; one or more transceivers; and one or more processors communicatively coupled to the one or more memories and the one or more transceivers, the one or more processors, either alone or in combination, configured to: receive, via the one or more transceivers, a maneuver request message from a host vehicle (HV), the maneuver request message indicating a requested maneuver of the HV and driving context information of the HV, wherein the driving context information includes one or more characteristics of operating the HV; obtain a determination result by determining whether the requested maneuver of the HV is accepted or rejected based on a planned maneuver of the RV, the requested maneuver of the HV, and the driving context information of the HV; and transmit, via the one or more transceivers, a maneuver response message indicating the requested maneuver of the HV being accepted or rejected by the RV based on the determination result.

In an aspect, a processing device of a host vehicle (HV) includes one or more memories; one or more transceivers; and one or more processors communicatively coupled to the one or more memories and the one or more transceivers, the one or more processors, either alone or in combination, configured to: transmit, via the one or more transceivers, a maneuver request message to one or more remote vehicles (RVs), the maneuver request message indicating a requested maneuver of the HV and driving context information of the HV, wherein the driving context information includes one or more characteristics of operating the HV; and receive, via the one or more transceivers, one or more maneuver response messages from the one or more RVs, the one or more maneuver response messages indicating the requested maneuver of the HV indicated by the maneuver request message being accepted or rejected by the one or more RVs.

In an aspect, a processing device of a remote vehicle (RV) includes means for receiving a maneuver request message from a host vehicle (HV), the maneuver request message indicating a requested maneuver of the HV and driving context information of the HV, wherein the driving context information includes one or more characteristics of operating the HV; means for obtaining a determination result by determining whether the requested maneuver of the HV is accepted or rejected based on a planned maneuver of the RV, the requested maneuver of the HV, and the driving context information of the HV; and means for transmitting a maneuver response message indicating the requested maneuver of the HV being accepted or rejected by the RV based on the determination result.

In an aspect, a processing device of a host vehicle (HV) includes means for transmitting a maneuver request message to one or more remote vehicles (RVs), the maneuver request message indicating a requested maneuver of the HV and driving context information of the HV, wherein the driving context information includes one or more characteristics of operating the HV; and means for receiving one or more maneuver response messages from the one or more RVs, the one or more maneuver response messages indicating the requested maneuver of the HV indicated by the maneuver request message being accepted or rejected by the one or more RVs.

In an aspect, a non-transitory computer-readable medium storing computer-executable instructions that, when executed by a processing device of a remote vehicle (RV), cause the processing device to: receive a maneuver request message from a host vehicle (HV), the maneuver request message indicating a requested maneuver of the HV and driving context information of the HV, wherein the driving context information includes one or more characteristics of operating the HV; obtain a determination result by determining whether the requested maneuver of the HV is accepted or rejected based on a planned maneuver of the RV, the requested maneuver of the HV, and the driving context information of the HV; and transmit a maneuver response message indicating the requested maneuver of the HV being accepted or rejected by the RV based on the determination result.

In an aspect, a non-transitory computer-readable medium storing computer-executable instructions that, when executed by a processing device of a host vehicle (HV), cause the processing device to: transmit a maneuver request message to one or more remote vehicles (RVs), the maneuver request message indicating a requested maneuver of the HV and driving context information of the HV, wherein the driving context information includes one or more characteristics of operating the HV; and receive one or more maneuver response messages from the one or more RVs, the one or more maneuver response messages indicating the requested maneuver of the HV indicated by the maneuver request message being accepted or rejected by the one or more RVs.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIG. 2A is a bird's eye view of a vehicle employing a radar-camera sensor module behind the windshield, according to aspects of the disclosure.

FIGS. 2B-2C are perspective views illustrating executing a maneuver based on maneuver sharing and coordination, according to aspects of the disclosure.

FIG. 3 illustrates an example architecture of an on-board computer (OBC) of a vehicle, according to aspects of the disclosure.

FIG. 4 illustrates an example neural network, according to aspects of the disclosure.

FIG. 5 shows a diagram illustrating an example process flow for maneuver sharing and coordination, according to aspects of the disclosure.

FIGS. 6A and 6B show an example structure of a maneuver sharing and coordination message, according to aspects of the disclosure.

FIG. 7 is a functional block diagram illustrating an example architecture for determining whether to accept or reject a requested maneuver, according to aspects of the disclosure.

FIG. 8A shows a diagram illustrating various states of a processing device configured to perform maneuver sharing and coordination, according to aspects of the disclosure.

FIG. 8B is a functional block diagram illustrating an example architecture for determining whether to transition from an awareness state to a maneuver negotiation state, according to aspects of the disclosure.

FIG. 9 is a flowchart illustrating an example method of maneuver sharing and coordination performed by a processing device of a remote vehicle (RV), according to aspects of the disclosure.

FIG. 10 is a flowchart illustrating an example method of maneuver sharing and coordination performed by a processing device of a host vehicle (HV), according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to driver assistance or automated driving technologies. Some aspects more specifically relate to engaging in a maneuver sharing and coordination session based on driving context information of a host vehicle (HV). In some aspects, the HV may send to one or more remote vehicles (RVs) a maneuver request message that includes characteristics of a requested maneuver and the driving context information of the HV. In some aspects, an RV may determine whether to accept or reject the requested maneuver and whether to provide proposed modifications to the driving context information and/or the requested maneuver based on the driving context information of the HV. In some aspects, the driving context information may include one or more characteristics of operating the HV. In some aspects, the one or more characteristics of operating the HV may include a driver's profile, an autonomy level of the HV, an automotive safety integrity level (ASIL) of the HV, or any combination thereof, in at least one example, an RV may utilize an offline-trained machine learning model (e.g., a neural network model) to infer the probability of a safe maneuver considering various inputs. In some aspects, if the probability is less than a threshold, the RV may use a second stage machine learning model to infer acceptable parameters to enable a safe maneuver. In an example, if a HV receives several different proposed modifications from different RVs, the HV may update the requested maneuver and/or the driving context information based on the most restrictive one of the proposed modifications.

Particular aspects of the subject matter described in this disclosure can be implemented to realize one or more of the following potential advantages. In some examples, by including the driving context information of the HV in the maneuver request message to one or more RVs, the RVs may determine whether to accept or reject a requested maneuver indicated by the maneuver request message further based on the driving context information of the HV. In some aspects, as a maneuver sharing and coordination session may be further based on the driving context information of the HV, an RV may better evaluate the requested maneuver and better respond the maneuver request message accordingly, and hence increase the overall driving safety and road safety.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation cNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

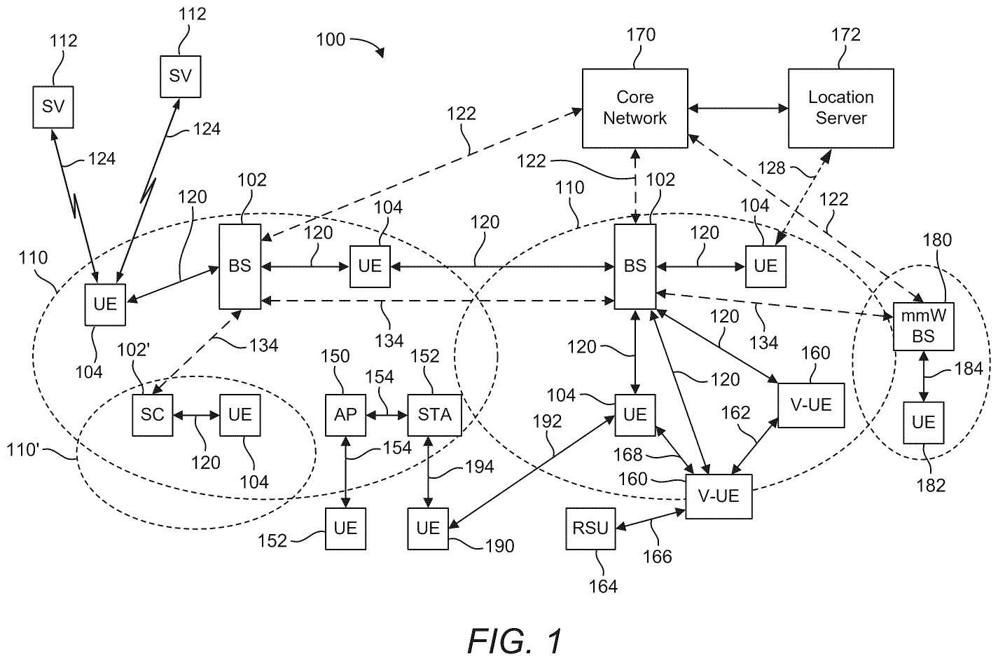

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (cMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

In some aspects, autonomous and semi-autonomous driving safety technologies use a combination of hardware (e.g., sensors, cameras, and radar) and software to help vehicles identify certain safety risks so they can warn the driver to act (in the case of an advanced driver assistance system (ADAS)), or act themselves (in the case of an automated driving systems (ADS)), to avoid a crash. A vehicle outfitted with an ADAS or ADS includes one or more camera sensors mounted on the vehicle that capture images of the scene in front of the vehicle, and also possibly behind and to the sides of the vehicle. Radar systems may also be used to detect objects along the road of travel, and also possibly behind and to the sides of the vehicle. Radar systems utilize RF waves to determine the range, direction, speed, and/or altitude of the objects along the road. More specifically, a transmitter transmits pulses of RF waves that bounce off any object(s) in their path. The pulses reflected off the object(s) return a small part of the RF waves' energy to a receiver, which is typically located at the same location as the transmitter. The camera and radar are typically oriented to capture their respective versions of the same scene.

A processor, such as a digital signal processor (DSP), within the vehicle analyzes the captured camera images and radar frames and attempts to identify objects within the captured scene. Such objects may be other vehicles, pedestrians, road signs, objects within the road of travel, etc. The radar system provides reasonably accurate measurements of object distance and velocity in various weather conditions. However, radar systems typically have insufficient resolution to identify features of the detected objects. Camera sensors, however, typically do provide sufficient resolution to identify object features. The cues of object shapes and appearances extracted from the captured images may provide sufficient characteristics for classification of different objects. Given the complementary properties of the two sensors, data from the two sensors can be combined (referred to as “fusion”) in a single system for improved performance.

To further enhance systems such as ADAS and ADS, especially at Level 3 and beyond, autonomous and semi-autonomous vehicles may utilize high definition (HD) map datasets, which contain significantly more detailed information and true-ground-absolute accuracy than those found in current conventional resources. Such HD maps may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by autonomous/semi-autonomous vehicles. HD maps may also provide electronic horizon predictive awareness, which enables autonomous/semi-autonomous vehicles to know what lies ahead.

Note that an autonomous or semi-autonomous vehicle may be, but need not be, a V-UE. Likewise, a V-UE may be, but need not be, an autonomous or semi-autonomous vehicle. An autonomous or semi-autonomous vehicle is a vehicle outfitted with an ADAS or ADS. A V-UE is a vehicle with cellular connectivity to a 5G or other cellular network. An autonomous or semi-autonomous vehicle that uses, or is capable of using, cellular techniques for positioning and/or navigation is a V-UE.

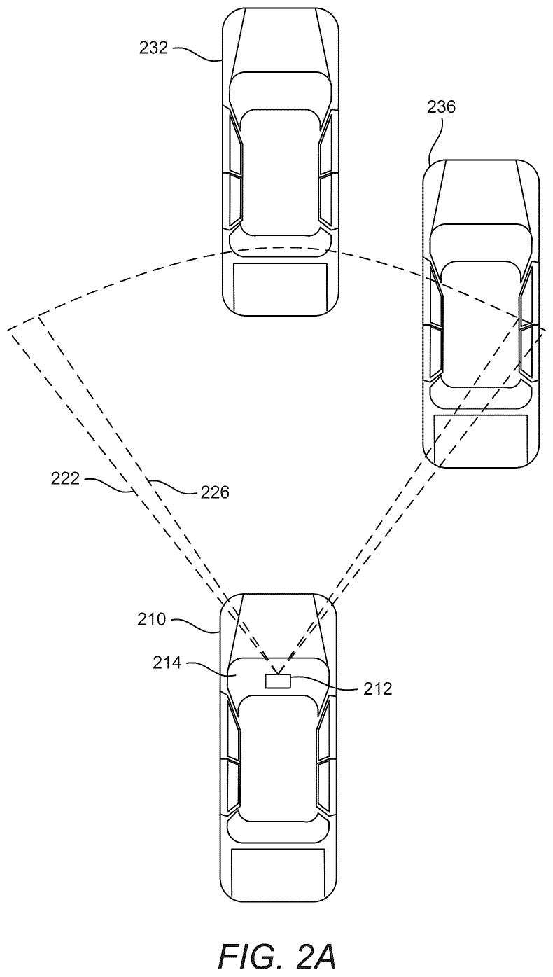

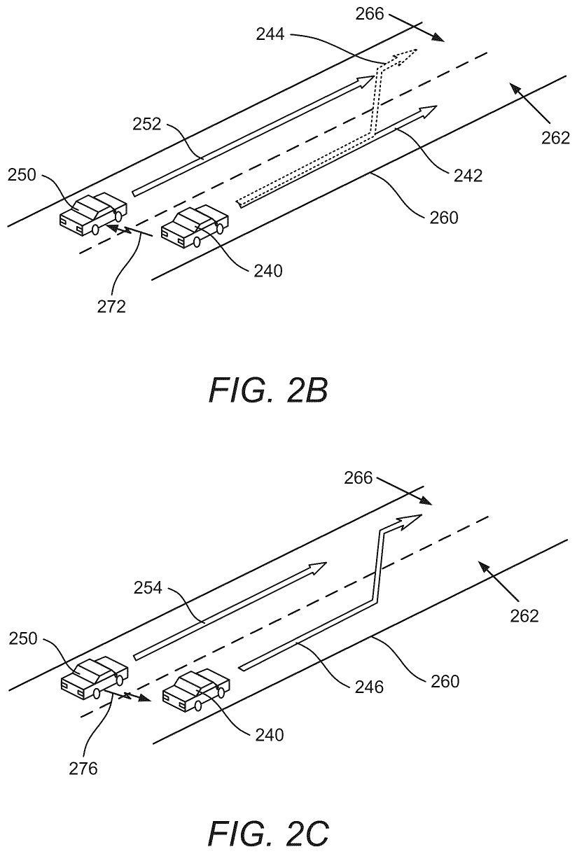

FIG. 2A is a bird's eye view of a vehicle 210 employing a radar-camera sensor module 212 behind the windshield 214, according to aspects of the disclosure. As shown in FIG. 2A, a vehicle 210 (referred to as an “ego vehicle” or a “host vehicle”) is illustrated that includes a radar-camera sensor module 212 located in the interior compartment of the host vehicle 210 behind the windshield 214. In some aspects, the host vehicle 210 may be a V2X-capable vehicle. The radar-camera sensor module 212 includes a radar component configured to transmit radar signals through the windshield 214 in a horizontal coverage zone 222 (shown by dashed lines), and receive reflected radar signals that are reflected off of any objects within the horizontal coverage zone 222. The radar-camera sensor module 212 further includes a camera component for capturing images based on light waves that are seen and captured through the windshield 214 in a horizontal coverage zone 226 (shown by dashed lines).

Although FIG. 2A illustrates an example in which the radar component and the camera component are co-located components in a shared housing, as will be appreciated, they may be separately housed in different locations within the host vehicle 210. For example, the camera may be located as shown in FIG. 2A, and the radar component may be located in the grill or front bumper of the host vehicle 210. Additionally, although FIG. 2A illustrates the radar-camera sensor module 212 located behind the windshield 214, it may instead be located in a rooftop sensor array, or elsewhere. Further, although FIG. 2A illustrates only a single radar-camera sensor module 212, as will be appreciated, the host vehicle 210 may have multiple radar-camera sensor modules 212 pointed in different directions (to the sides, the front, the rear, etc.). The various radar-camera sensor modules 212 may be under the “skin” of the vehicle (e.g., behind the windshield 214, door panels, bumpers, grills, etc.) or within a rooftop sensor array.

The radar-camera sensor module 212 may detect one or more (or none) objects relative to the host vehicle 210. In the example of FIG. 2A, there are two objects, vehicles 232 and 236, within the horizontal coverage zones 222 and 226 that the radar-camera sensor module 212 can detect. The radar-camera sensor module 212 may estimate parameters (attributes) of the detected object(s), such as the position, range, direction, speed, size, classification (e.g., vehicle, pedestrian, road sign, etc.), and the like. The radar-camera sensor module 212 may be employed onboard the host vehicle 210 for automotive safety applications, such as adaptive cruise control (ACC), FCW, collision mitigation or avoidance via autonomous braking, LDW, and the like.

Co-locating the camera and radar permits these components to share electronics and signal processing, and in particular, enables early radar-camera data fusion. For example, the radar and camera may be integrated onto a single board. A joint radar-camera alignment technique may be employed to align both the radar and the camera. However, co-location of the radar and camera is not required to practice the techniques described herein.

FIGS. 2B-2C are perspective views illustrating executing a maneuver based on maneuver sharing and coordination, according to aspects of the disclosure. As shown in FIG. 2B, a host vehicle 240 (which may correspond to the host vehicle 210) and a neighboring vehicle 250 are on a road segment 260. In this example, the host vehicle 240 may be on a right lane 262 of the road segment 260 with a planned maneuver 242 to be executed within a time period. Also, in this example, the neighboring vehicle 250 may be on a left lane 266 of the road segment 260 with a planned maneuver 252 to be executed within the time period.

As shown in FIG. 2B, the host vehicle 240 may want to execute a lane change maneuver 244, which may collide with the planned maneuver 252 and may increase the chance of a collision between the host vehicle 240 and the neighboring vehicle 250. In some aspects, the host vehicle 240 may engage in a maneuver sharing and coordination session with the neighboring vehicle 250 in order to share and coordinate maneuvers using one or more communication links (e.g., based on V2X communication technologies) between the host vehicle 240 and the neighboring vehicle 250.

For example, as shown in FIG. 2B, the host vehicle 240 may send a maneuver request message (as indicated by arrow 272) to the neighboring vehicle 250 (or also referred to as a “remote vehicle” in this disclosure). In some aspects, the maneuver request message may include information describing various characteristics of the maneuver 244 (or also referred to as a “requested maneuver”), such as a target road resource, temporal characteristics, and/or kinematic characteristics of the maneuver 244.

As shown in FIG. 2C, the neighboring vehicle 250 may analyze the characteristics of the maneuver 244 as provided in the maneuver request message and determine if the maneuver 244 is acceptable. In some aspects, in the case that the neighboring vehicle 250 determines that the maneuver 244 is acceptable, the neighboring vehicle 250 may send a maneuver response message (as indicated by arrow 276) to the host vehicle 240, where the maneuver response message may indicate that the requested maneuver 244 is accepted by the neighboring vehicle 250. In some aspects, the host vehicle 240, after obtaining the acceptance from the neighboring vehicle 250, may plot an updated maneuver 246 based on the requested maneuver 244. In this example, the neighboring vehicle 250 may also plot an updated maneuver 254 based on the requested maneuver 244 in order to further lower the chance of collision.

In some other examples, in the case that the neighboring vehicle 250 determines that the maneuver 244 is not acceptable, the neighboring vehicle 250 may send a maneuver response message to the host vehicle 240, where the maneuver response message may indicate that the requested maneuver 244 is rejected by the neighboring vehicle 250. In some aspects, the host vehicle 240 and the neighboring vehicle 250 may continue execution of the planned maneuver 252 and the planned maneuver 252.

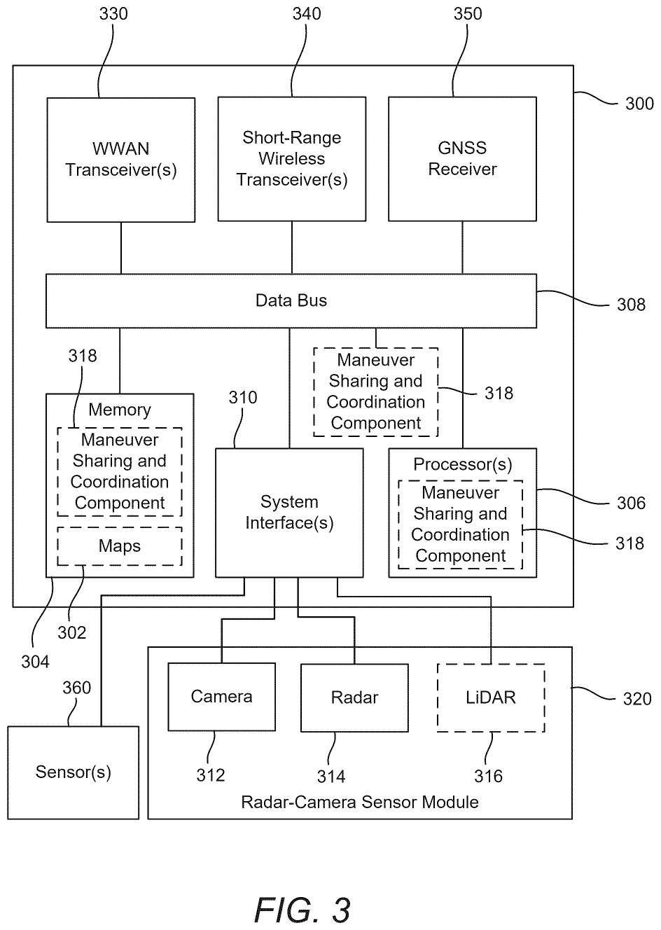

FIG. 3 illustrates an example architecture of an on-board computer (OBC) 300 of a vehicle, according to aspects of the disclosure. In an aspect, the OBC 300 may be part of an ADAS or ADS. The OBC 300 may also be the V-UE of a vehicle (e.g., the host vehicle 210 in FIG. 2A, or the host vehicle 240 and/or the neighboring vehicle 250 in FIGS. 2B-2C). The OBC 300 includes a non-transitory computer-readable storage medium, i.e., memory 304, and one or more processors 306 in communication with the memory 304 via a data bus 308. The memory 304 includes one or more storage modules storing computer-readable instructions executable by the one or more processors 306 to perform the functions of the OBC 300 described herein. For example, the one or more processors 306 in conjunction with the memory 304 may implement the various operations described herein.

One or more radar-camera sensor modules 320 onboard the vehicle may be coupled to the OBC 300 (only one is shown in FIG. 3 for simplicity). In some aspects, the radar-camera sensor module 320 includes at least one camera 312, at least one radar 314, and at least one optional light detection and ranging (lidar) sensor 316. The OBC 300 also includes one or more system interfaces 310 connecting the one or more processors 306, by way of the data bus 308, to the radar-camera sensor module 320 and, optionally, other vehicle sub-systems (not shown).

The OBC 300 also includes, at least in some cases, one or more wireless wide area network (WWAN) transceivers 330 configured to communicate via one or more wireless communication networks (not shown), such as an NR network, an LTE network, a Global System for Mobile communication (GSM) network, and/or the like. The one or more WWAN transceivers 330 may be connected to one or more antennas (not shown) for communicating with other network nodes, such as other V-UEs, pedestrian UEs, infrastructure access points, roadside units (RSUs), base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 330 may be variously configured for transmitting and encoding signals (e.g., messages, indications, information, and so on), and, conversely, for receiving and decoding signals (e.g., messages, indications, information, pilots, and so on) in accordance with the designated RAT.

The OBC 300 also includes, at least in some cases, one or more short-range wireless transceivers 340 (e.g., a Wi-Fi transceiver, a BLUETOOTH® transceiver, etc.). The one or more short-range wireless transceivers 340 may be connected to one or more antennas (not shown) for communicating with other network nodes, such as other V-UEs, pedestrian UEs, infrastructure access points, RSUs, etc., via at least one designated RAT (e.g., cV2X), IEEE 802.11p (also known as wireless access for vehicular environments (WAVE)), dedicated short-range communication (DSRC), etc.) over a wireless communication medium of interest. The one or more short-range wireless transceivers 340 may be variously configured for transmitting and encoding signals (e.g., messages, indications, information, and so on), and, conversely, for receiving and decoding signals (e.g., messages, indications, information, pilots, and so on) in accordance with the designated RAT.

As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing).

The OBC 300 also includes, at least in some cases, a global navigation satellite system (GNSS) receiver 350. The GNSS receiver 350 may be connected to one or more antennas (not shown) for receiving satellite signals. The GNSS receiver 350 may comprise any suitable hardware and/or software for receiving and processing GNSS signals. The GNSS receiver 350 requests information and operations as appropriate from the other systems, and performs the calculations necessary to determine the vehicle's position using measurements obtained by any suitable GNSS algorithm.

In an aspect, the OBC 300 may utilize the one or more WWAN transceivers 330 and/or the one or more short-range wireless transceivers 340 to download one or more maps 302 that can then be stored in memory 304 and used for vehicle navigation. Map(s) 302 may be one or more high definition (HD) maps, which may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by the vehicle. Map(s) 302 may also provide electronic horizon predictive awareness, which enables the vehicle to know what lies ahead.

In some aspects, the vehicle that includes the OBC 300 may further include one or more sensors 360 that may be coupled to the one or more processors 306 via the one or more system interfaces 310. The one or more sensors 360 may provide means for sensing or detecting information related to the state and/or environment of the vehicle, such as speed, heading (e.g., compass heading), headlight status, gas mileage, etc. By way of example, the one or more sensors 360 may include an odometer a speedometer, a tachometer, an accelerometer (e.g., a micro-electromechanical system-s (MEMS) device), a gyroscope, a geomagnetic sensor (e.g., a compass), an altimeter (e.g., a barometric pressure altimeter), etc. Although shown as located outside the OBC 300, some of these sensors 360 may be located on the OBC 300 and some may be located elsewhere in the vehicle.

The OBC 300 may further include a maneuver sharing and coordination component 318. The maneuver sharing and coordination component 318 may be a hardware circuit that is part of or coupled to the one or more processors 306 that, when executed, causes the OBC 300 to perform the functionality described herein. In other aspects, the maneuver sharing and coordination component 318 may be external to the one or more processors 306 (e.g., part of a positioning processing system, integrated with another processing system, etc.). Alternatively, the maneuver sharing and coordination component 318 may be one or more memory modules stored in the memory 304 that, when executed by the one or more processors 306 (or positioning processing system, another processing system, etc.), cause the OBC 300 to perform the functionality described herein. FIG. 3 illustrates possible locations of the maneuver sharing and coordination component 318, which may be, for example, part of the memory 304, the one or more processors 306, or any combination thereof, or may be a standalone component.

In an aspect, the camera 312 may capture image frames (also referred to herein as camera frames) of the scene within the viewing area of the camera 312 (as illustrated in FIG. 2A as horizontal coverage zone 226) at some periodic rate. Likewise, the radar 314 may capture radar frames of the scene within the viewing area of the radar 314 (as illustrated in FIG. 2A as horizontal coverage zone 222) at some periodic rate. The periodic rates at which the camera 312 and the radar 314 capture their respective frames may be the same or different. Each camera and radar frame may be timestamped. Thus, where the periodic rates are different, the timestamps can be used to select simultaneously, or nearly simultaneously, captured camera and radar frames for further processing (e.g., fusion).

For convenience, the OBC 300 is shown in FIG. 3 as including various components that may be configured according to the various examples described herein. It will be appreciated, however, that the illustrated components may have different functionality in different designs. In particular, various components in FIG. 3 are optional in alternative configurations and the various aspects include configurations that may vary due to design choice, costs, use of the device, or other considerations. For brevity, illustration of the various alternative configurations is not provided herein, but would be readily understandable to one skilled in the art.

The components of FIG. 3 may be implemented in various ways. In some implementations, the components of FIG. 3 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 302 to 350 may be implemented by processor and memory component(s) of the OBC 300 (e.g., by execution of appropriate code and/or by appropriate configuration of processor components). For simplicity, various operations, acts, and/or functions are described herein as being performed “by a UE,” “by an OBC,” or “by a vehicle.” However, as will be appreciated, such operations, acts, and/or functions may actually be performed by specific components or combinations of components of the OBC 300, such as the one or more processors 306, the one or more transceivers 330 and 340, the memory 304, the maneuver sharing and coordination component 318, etc.

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on. In some examples, the application of machine learning relates to generation of a safety score associated with planning a maneuver or executing a maneuver. In some examples, the application of machine learning relates to generation of one or more parameters associated with planning characteristics of a maneuver or updating characteristics associated with a maneuver.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

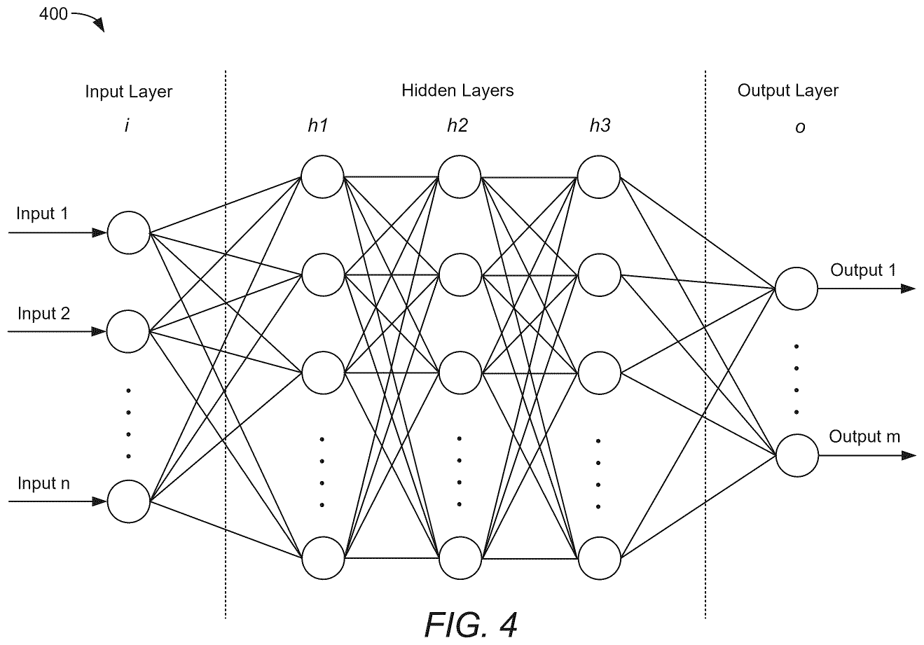

FIG. 4 illustrates an example neural network 400, according to aspects of the disclosure. The neural network 400 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

In some aspects, the maneuver sharing and coordination as illustrated in FIGS. 2B-2C may be performed based on the host vehicle (HV) sending a maneuver request message to one or more remote vehicles (RVs), where the maneuver request message may include information describing various characteristics of a requested maneuver, such as a target road resource, temporal characteristics, and/or kinematic characteristics of the requested maneuver. In some aspects, the maneuver sharing and coordination may further consider driving context information of the HV, where the driving context information may include one or more characteristics of operating the HV. In some aspects, the one or more characteristics of operating the HV may include a driver's profile (e.g., aggressive, conservative, or normal, which may correspond to categorization based on comparing an aggressive level of the driver against a higher threshold and a lower threshold) of the HV, an autonomy level of the HV (e.g., Level 0-5), an automotive safety integrity level (ASIL) of the HV (e.g., Rating A-D, where D may correspond to the highest integrity and A may correspond to the lowest integrity), or any combination thereof. In some aspects, further based on the driving context information of the HV, an RV may better evaluate the requested maneuver and better respond the maneuver request message accordingly, and hence increase the overall driving safety and road safety.

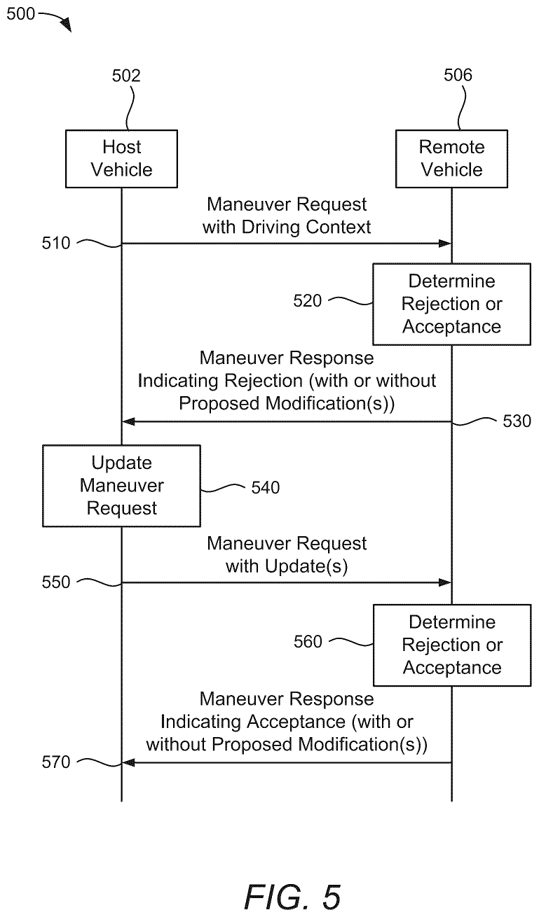

FIG. 5 shows a diagram illustrating an example process flow 500 for maneuver sharing and coordination, according to aspects of the disclosure. In some aspects, the process flow 500 may correspond to operations performed by a host vehicle (HV) 502 and one or more remote vehicles (RVs), with only one RV 506 depicted in FIG. 5 as a non-limiting example. In some aspects, the host vehicle 502 may correspond to the host vehicle 210 in FIG. 2A or the host vehicle 240 in FIGS. 2B and 2C. In some aspects, the remote vehicle 506 may correspond to the neighboring vehicle 250 in FIGS. 2B and 2C. As noted above, one or more operations performed by an OBC or a processing device of a vehicle in this disclosure may be referred to as performed by such vehicle.

As shown in FIG. 5, at stage 510, the HV 502 may send a maneuver request message to the RV 506. In some aspects, the maneuver request message may include information describing various characteristics of a requested maneuver the HV 502 intends to execute, such as a target road resource, temporal characteristics, and/or kinematic characteristics of the requested maneuver. In some aspects, the maneuver request message may include driving context information of the HV 502. In some aspects, the driving context information may include one or more characteristics of operating the HV 502. In some aspects, the one or more characteristics of operating the HV 502 may include a driver's profile of the HV 502, an autonomy level of the HV 502, an ASIL of the HV 502, or any combination thereof.

At stage 520 after stage 510, the RV 506 (which is one of the one or more RVs receiving the maneuver request message) may obtain a determination result by determining whether the requested maneuver of the HV 502 is accepted or rejected based on a planned maneuver of the RV 506, the requested maneuver of the HV 502, the driving context information of the HV 502, the driving context information of the RV 506, and/or environmental conditions (e.g., road conditions, traffic conditions, etc.). In some aspects, the determination result may correspond to the requested maneuver of the HV 502 is accepted by the RV 506, the requested maneuver of the HV 502 is accepted by the RV 506 with one or more proposed modifications (with respect to the context information and/or the requested maneuver), the requested maneuver of the HV 502 is rejected by the RV 506 with the one or more proposed modifications (with respect to the context information and/or the requested maneuver), or the requested maneuver of the HV 502 is rejected by the RV 506. In some aspects, the RV 506 at stage 530 may obtain the determination result based on applying one or more machine learning models, one or more non-machine learning based decision-making algorithms, or a combination thereof.

At stage 530, the RV 506 may transmit a maneuver response message to the HV 502, where the maneuver response message may indicate that the requested maneuver of the HV 502 is accepted or rejected by the RV 506 based on the determination result from stage 520. In some aspects, the maneuver response message may further indicate if the acceptance or rejection of the requested maneuver is accompanied with one or more proposed modifications (with respect to the context information of the HV 502 and/or the requested maneuver). In this example, the RV 506 may determine to reject the requested maneuver of the HV 502, which may be accompanied with or without one or more proposed modifications.

In some aspects, at stage 530, the maneuver response message may further indicate a request of a raw sensor sharing session between the HV 502 and the RV 506. In some aspects, the RV 506 may make such request for a raw sensor sharing session when the driving context information of the HV 502 indicates that the driver of the HV 502 is aggressive and the HV 502 has a low ASIL rating.

At stage 540, the HV 502 may prepare a second maneuver request message including updated context information and/or an updated requested maneuver, in view of the one or more proposed modifications from stage 530, when applicable. At stage 540, the HV 502 may transmit the second maneuver request message to the RV 506.

In some aspects, the HV 502 may transmit the maneuver request message to multiple RVs at stage 510; and the HV 502 may receive multiple maneuver response messages from the RVs. In some aspects, the HV 502 may prepare the updated requested maneuver to be included in the second maneuver request message satisfying all restrictions based on the one or more proposed modifications included in the multiple maneuver response messages to the requested maneuver of the HV 502. In some aspects, the HV 502 may prepare the updated driving context information to be included in the second maneuver request message satisfying all restrictions based on the one or more proposed modifications included in the multiple maneuver response messages to the driving context information of the HV 502.

At stage 550, the HV 502 may transmit the second maneuver request message to the RV 506 with the updates from stage 540. In some aspects, the RV 506 at stage 560 may obtain a second determination result by determining whether the requested maneuver of the HV 502 from stage 550 is accepted or rejected based on the planned maneuver of the RV 506, the requested maneuver (or updated requested maneuver when applicable) of the HV 502, the driving context information (or updated driving context information when applicable) of the HV 502, the driving context information of the RV 506, and/or environmental conditions. In some aspects, the RV 506 at stage 560 may obtain the second determination result based on applying one or more machine learning models, one or more non-machine learning based decision-making algorithms, or a combination thereof.

At stage 570, the RV 506 may transmit a second maneuver response message to the HV 502, where the second maneuver response message may indicate that the requested maneuver of the HV 502 from stage 550 is accepted or rejected by the RV 506 based on the second determination result from stage 560. In some aspects, the second maneuver response message may further indicate if the acceptance or rejection of the requested maneuver is accompanied with one or more proposed modifications. In this example, the RV 506 may determine to accept the requested maneuver of the HV 502 from stage 550, with or without one or more proposed modifications.

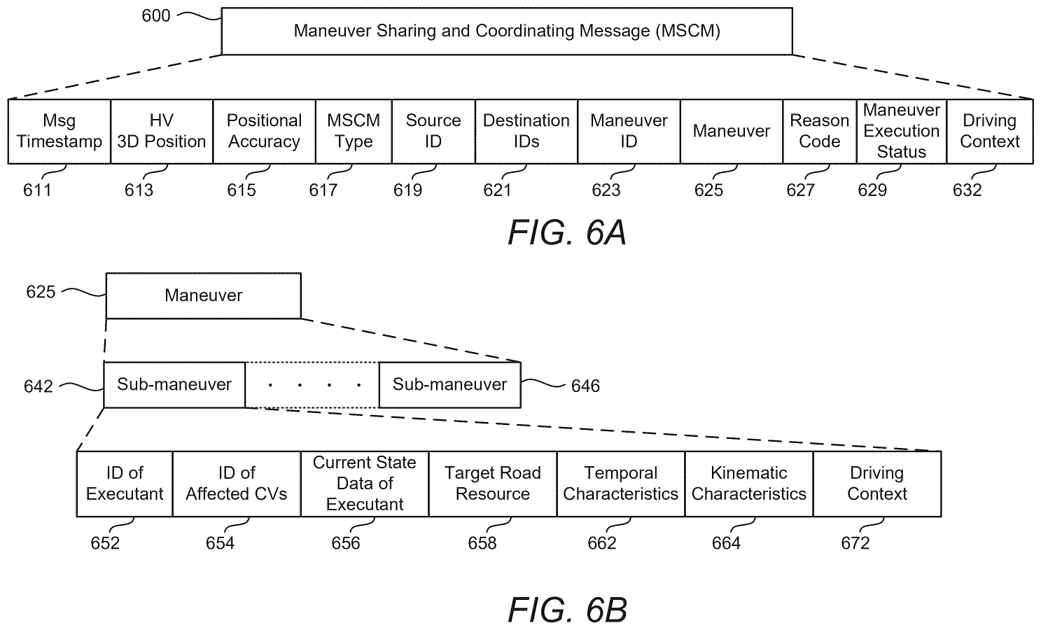

FIGS. 6A and 6B show an example structure of a maneuver sharing and coordination message (MSCM) 600, according to aspects of the disclosure. In some aspects, the MSCM 600 in FIGS. 6A and 6B corresponds to a format, as a non-limiting example, that may be used by the maneuver request messages and the maneuver response message as illustrated in FIG. 5. In some aspects, the MSCM 600 may be transmitted based on V2X communication technologies. In some aspects, the position and/or order of various data fields illustrated in FIGS. 6A-6B may vary, and some of the data fields illustrated in FIGS. 6A-6B may be omitted.

As shown in FIG. 6A, the MSCM 600 may include a data field 611 for message (Msg) timestamp, a data field 613 for HV three-dimensional (3D) position, a data field 615 for positional accuracy, a data field 617 for MSCM type, and a data field 619 for source identifier (ID). In some examples, the data fields 611-619 according to some standards (e.g., SAE International (SAE, formerly the Society of Automotive Engineers) J3186 standard) may be mandatory.

In some aspects, the MSCM type at the data field 617 may indicate a type of the MSCM 600. For example, the MSCM type may specify whether the MSCM 600 is a maneuver request message or a maneuver response message, or any other applicable types of messages for exchanging information during a maneuver sharing and coordination session. In some aspects, the source ID at the data field 619 may indicate the identity of a vehicle that generates and transmits the MSCM 600.

In some aspects, the MSCM 600 may further include a data field 621 for one or more destination identifiers (IDs), a data field 623 for maneuver identifier (ID), a data field 625 for maneuver, a data field 627 for reason code, and a data field 629 for maneuver extension. In some examples, the data fields 621-629 according to some standards (e.g., SAE J3186 standard) may be optional. In some aspects, the MSCM 600 may further include a data field 632 for driving context information.

In some aspects, the destination IDs at the data field 621 may indicate the identity of one or more vehicles that are the intended recipients of the MSCM 600. In some aspects, the maneuver ID at the data field 623 may identify a maneuver sharing and coordination session, such that the HV and one or more RVs may properly associate the MSCM 600 with a corresponding maneuver sharing and coordination session. In some aspects, the maneuver execution status at the data field 629 may indicate the status of executing a maneuver by an HV, where the maneuver has been negotiated and accepted by one or more corresponding RVs during a maneuver sharing and coordination session.

In some aspects, the maneuver at the data field 625 may provide various characteristics of a maneuver. In some aspects, the data field 625 for the maneuver may be used to send a requested maneuver from an HV to an RV in a maneuver request message, or to send the proposed modifications to the requested maneuver from an RV to an HV in a maneuver response message.

As shown in FIG. 6B, in some aspects, the data field 625 may include one or more data fields 642 and 646 for providing the maneuver in the form of one or more sub-maneuvers at the respective data fields (e.g., data fields 642 and 646). In some aspects, a data field for sub-maneuver (e.g., the data field 642) may include a data field 652 for identifier (ID) of an executant of the sub-maneuver, a data field 654 for identifiers (IDs) of affected connected vehicles (CVs), a data field 656 for current state data of the executant (e.g., heading and/or speed), a data field 658 for target road resource, a data field 662 for temporal characteristics of the sub-maneuver, a data field 664 for kinematic characteristics of the sub-maneuver, and a data field 672 for driving context information.

In some aspects, the temporal characteristics of the sub-maneuver may include a start time and/or an end time of the sub-maneuver. In some aspects, the kinematic characteristics may include a minimum speed and/or a maximum speed of the sub-maneuver. In some aspects, the driving context information may include a driver's profile (e.g., aggressive, conservative, or normal) of the HV, an autonomy level of the HV (e.g., Level 0-5), an ASIL of the HV, or any combination thereof.

In some aspects, the data field 632 in FIG. 6A and/or the data field 672 in FIG. 6B may be used to send the driving context information of the HV from the HV to one or more RVs in a maneuver request message, or to send the proposed modifications to the driving context information of the HV from an RV to the HV in a maneuver response message.

In at least one example, the driving context information of the HV from the HV to one or more RVs may be provided in the data field 672 in a maneuver request message. For example, below is a simplified example of a sub-maneuver data element.

SubManeuver ::= SEQUENCE {

| executantID | TemporaryID, | | |
|---|---|---|---|
| affectedCVIDs | TemporaryIDPointer, | | |
| currentStateData | CurrentStateData, | | |
| targetRoadResource | TargetRoadResource, | | OPTIONAL, |
| startTime | MsgTimeStamp, | | -- Temporal characteristics |
| endTime | MsgTimeStamp, | | |
| minSpeed | Speed | OPTIONAL, | -- Kinematic characteristics |

| | | |
|---|---|---|
| maxSpeed | Speed | OPTIONAL, |
| driverProfile | profile | OPTIONAL, |
| autonomyLevel | aLevel | OPTIONAL, |
| functionalSafetyLevel | asilLevel | OPTIONAL, |

...
}

As shown in the sub-maneuver data element, “executantID” may correspond to an ID of an executant of the sub-maneuver provided at data field 652; “affectedCVIDs” may correspond to IDs of affected CVs provided at data field 654; “currentStateData” may correspond to current state data of the executant provided at data field 656; and “targetRoadResource” may correspond to a target road resource provided at data field 658. In some aspects, “startTime” and “endTime” may correspond to the temporal characteristics provided at data field 662; and “minSpeed” and “maxSpeed” may correspond to kinematic characteristics provided at data field 664. In some aspects, “driverProfile,” “driverProfile,” and “functionalSafetyLevel” may correspond to the driving context information (of the HV) provided at data field 672.

In at least another example, the proposed modifications to the driving context information of the HV from an RV to the HV may be provided in the data field 632 in a maneuver response message. For example, below is a simplified example of an MSCM data element.

ExampleMSCM ManeuverSharingandCoordinatingMessage ::= SEQUENCE {

| mSCMTimestamp | MsgTimeStamp, | |
|---|---|---|
| mSCMType | 2, | -- Maneuver Response |
| sourceID | TemporaryID, | -- RV's ID |
| destinationIDs | TemporaryIDList, | -- HV's ID |
| maneuverID | ManeuverID, | |
| maneuver | Maneuver, | -- OPTIONAL |

...

| | | |
|---|---|---|
| reasonCode | ReasonCode | -- OPTIONAL |
| proposedDriverProfile | DriverClass | -- OPTIONAL |
| proposedAutonomyLevel | AutonomyLevel | -- OPTIONAL |
| sensorSharingSession | RequestSensorData | -- OPTIONAL |

}

As shown in the MSCM data element, “mSCMTimestamp” may correspond to a message timestamp provided at data field 611; “mSCMType” may correspond to an MSCM type (e.g., type 2 in this example, identifying the MSCM as a maneuver response message) provided at data field 617; “sourceID” may correspond to a source ID provided at data field 619; and “destinationIDs” may correspond to a list of one or more destination IDs provided at data field 621. In some aspects, “maneuver” may correspond to various characteristics of a maneuver provided at data field 625; and “reasonCode” may correspond to the reason code provided at data field 627. In some aspects, “proposedDriverProfile” and “proposedAutonomyLevel” may correspond to the proposed modifications to the driving context information of the HV provided at data field 632. In some aspects, the MSCM may further include “sensorSharingSession” for triggering a raw sensor sharing functionality, which can be provided at data field 632 as well.

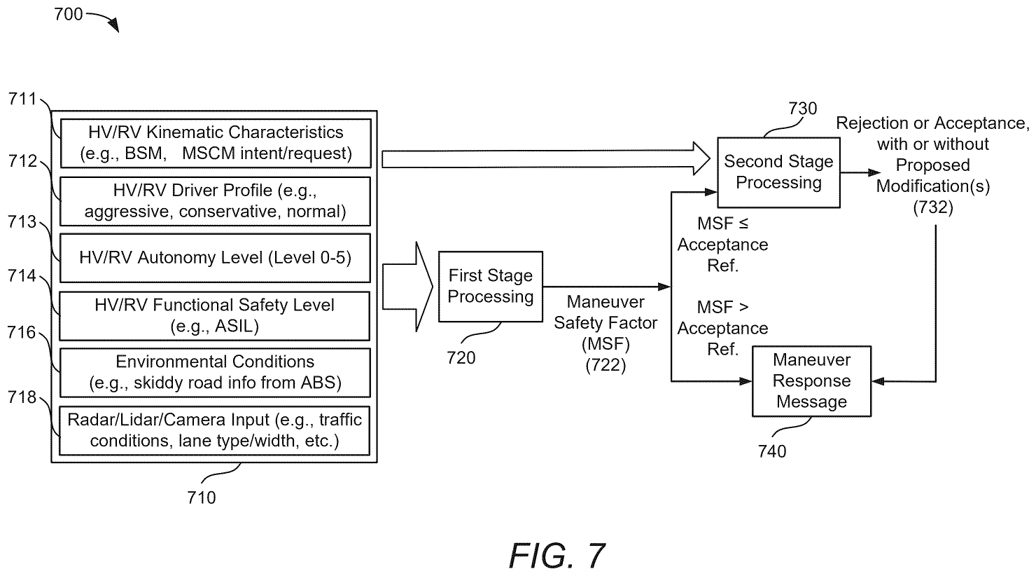

FIG. 7 is a functional block diagram illustrating an example architecture 700 for determining whether to accept or reject a requested maneuver, according to aspects of the disclosure. In some aspects, the architecture 700 may correspond to operations performed by a processing device onboard a vehicle (e.g., an RV).

In some aspects, an RV may obtain information 710 relevant to determining whether to accept or reject a requested maneuver included in a maneuver request message from an HV. In some aspects, the obtained information 710 may include the kinematic characteristics 711 of the HV and/or the RV. In some aspects, the kinematic characteristics of the RV may be obtained based measurements of the speed, position, and/or various measurements or readings of the powertrain of the RV. In some aspects, the kinematic characteristics of the RV may further include a planned maneuver of the RV. In some aspects, the kinematic characteristics of the HV may be obtained based on one or more basic safety messages (BSMs) from the HV, the maneuver request message (e.g., a MSCM) including the intent or request to implement the requested maneuver.

In some aspects, the obtained information 710 may include the driver profiles 712 of the HV and/or the RV. In some aspects, the driver profile of the RV may be obtained based on recognizing the driver of the RV, retrieving the recorded information about the driver, monitoring the soberness of the driver, and/or analyzing the driving style of the driver based on the kinematic characteristics of the RV. In some aspects, the driver profile of the HV be included in the driving context information of the HV and may be obtained based on the maneuver request message (e.g., a MSCM) including the driving context information. In some aspects, the driving context information of the HV may indicate that the driver of the HV is aggressive, conservative, or normal.

In some aspects, the obtained information 710 may include the autonomy levels 713 of the HV and/or the RV. In some aspects, the autonomy level of the RV may be obtained based on the ADAS or ADS of the RV. In some aspects, the autonomy level of the HV be included in the driving context information of the HV and may be obtained based on the maneuver request message (e.g., a MSCM) including the driving context information. In some aspects, the autonomy level of the HV may indicate that the ADAS or the ADS of the HV is at which one of autonomy Level 0-5.

In some aspects, the obtained information 710 may include the automotive safety integrity levels 714 (e.g., ASIL) of the HV and/or the RV. In some aspects, the ASIL of the RV may be obtained based on the ADAS or ADS of the RV. In some aspects, the ASIL level of the HV be included in the driving context information of the HV and may be obtained based on the maneuver request message (e.g., a MSCM) including the driving context information. In some aspects, the ASIL level of the HV may indicate that the ADAS or the ADS of the HV is at which one of ASIL rating A-D.

In some aspects, the obtained information 710 may include the environmental conditions 716 of the RV. In some aspects, the environmental conditions 716 may include road conditions and/or traffic conditions. In some aspects, the environmental conditions of the RV may be obtained based on the ADAS or ADS and/or various sensors of the RV. For examples, the RV may determine if the road condition is skiddy based on parameters or measurements in association with an anti-lock braking system (ABS) of the RV. In some aspects, an RV may obtain the raw sensor information from the HV, provided that the HV and the RV engage in a raw sensor sharing session. In some aspects, the obtained information 710 may further include the input 718 from one or more sensing devices such as a radar, a lidar, and/or a camera of the RV. In some aspects, the input may indicate traffic conditions, a lane type, and/or a lane width as observed by the RV.

As shown in FIG. 7, the RV may perform a first stage processing 720 using the obtained information 710 as input and generate a maneuver safety factor (MSF) 722 as an output. In some aspects, the first stage processing 720 may be based on a first machine learning model (e.g., a neural network model). In some aspects, the first machine learning model for the first stage processing 720 may be trained offline by the RV. In some aspects, the first stage processing 720 may be based on a first non-machine learning based decision-making algorithm (e.g., including a set of equations and/or combination logics). In some aspects, the first stage processing 720 may infer or determine the MSF of the requested maneuver of the HV, where the MSF may indicate the probability of the requested maneuver of the HV being a safe lane change maneuver considering various factors based on the obtained information 710.

After the MSF 722 is inferred or determined, in a case that the MSF is equal to or less than an acceptance reference value, the RV may perform a second stage processing 730 using the obtained information 710 as input and generate a decision 732 as an output. In some aspects, the decision 732 may correspond to the requested maneuver of the HV is (i) rejected by the RV, (ii) accepted by the RV with one or more proposed modifications, (iii) rejected by the RV with the one or more proposed modifications, or (iv) rejected by the RV. In some aspects, the one or more proposed modifications may be determined based on the second stage processing 730. In some aspects, the one or more proposed modifications may include a proposed modification to the driving context information of the HV. In some aspects, the one or more proposed modifications may include a proposed modification to the requested maneuver of the HV. In some aspects, the RV may prepare a maneuver response message (e.g., a MSCM as illustrated in FIG. 6, with the type being a maneuver response message) at block 740 based on the decision 732.

In some aspects, the second stage processing 730 may be based on a second machine learning model (e.g., a neural network model). In some aspects, the second machine learning model for the second stage processing 730 may be trained offline by the RV. In some aspects, the second stage processing 730 may be based on a second non-machine learning based decision-making algorithm (e.g., including a set of equations and/or combination logics).

In some aspects, in a case that the MSF is greater than the acceptance reference value, the RV may determine that the requested maneuver of the HV is accepted, and the RV may prepare the maneuver response message at block 740 based on the requested maneuver of the HV being accepted.

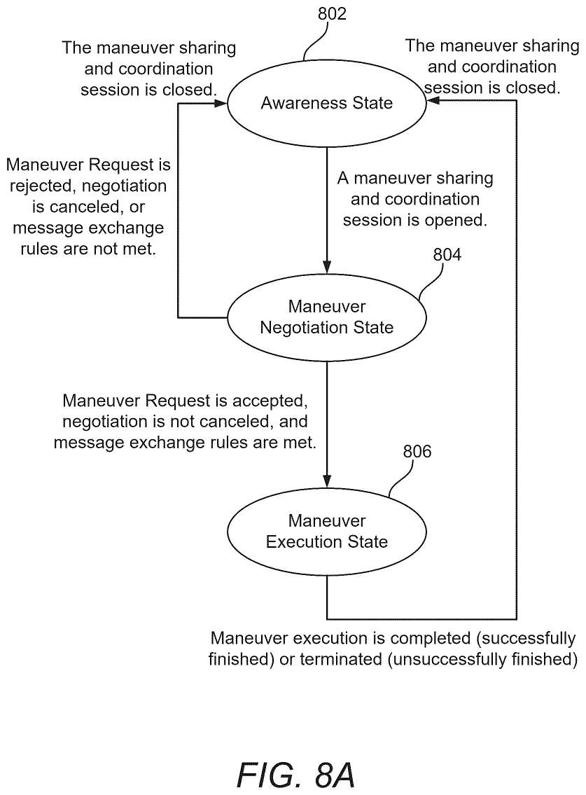

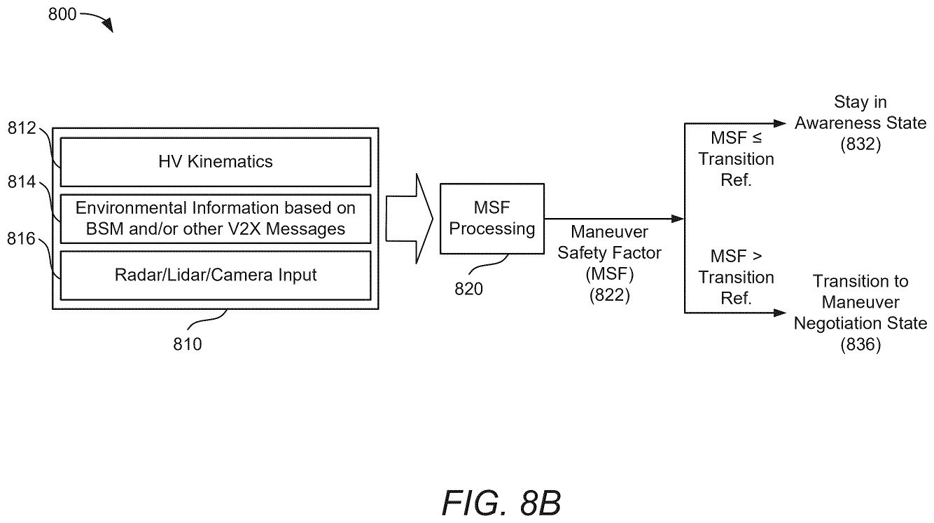

FIG. 8A shows a diagram illustrating various states of a processing device (e.g., a processing device onboard an HV) configured to perform maneuver sharing and coordination, according to aspects of the disclosure. As shown in FIG. 8A, the processing device of the HV may start at an awareness state 802. In some aspects, the processing device of the HV may determine whether it may transition from the awareness state 802 to a maneuver negotiation state 804 and open a maneuver sharing and coordination session.

In some aspects, at the maneuver negotiation state 804, in order to negotiate if a requested maneuver of the HV is acceptable (or subjected to one or more modifications), the HV may send one or more maneuver request messages to one or more RVs and receive one or more maneuver response messages form the one or more RVs as illustrated in FIG. 5. In some aspects, if the requested maneuver is rejected, the negotiation is canceled, or the message exchange rules are not met, the processing device of the HV may transition from the maneuver negotiation state 804 to the awareness state 802, and the maneuver sharing and coordination session may be closed. In some aspects, if the requested maneuver is accepted, the negotiation is not canceled, and the message exchange rules are met, the processing device of the HV may transition from the maneuver negotiation state 804 to a maneuver execution state 806 to execute the maneuver as negotiated and accepted.

In some aspects, at the maneuver execution state 806, the processing device of the HV may transition from the maneuver execution state 806 to the awareness state 802 and the maneuver sharing and coordination session may be closed, based on the maneuver execution is completed (e.g., successfully finished) or terminated (e.g., unsuccessfully finished).

In some aspects, as the HV may negotiate with one or more RVs with respect to a requested maneuver of the HV, the HV may receive various sets of proposed modifications (to the driving context information of the HV and/or to the requested maneuver) with rejection and/or acceptance. In some aspects, in order to increase the chance of obtaining an accepted maneuver during the maneuver negotiation state 804, the HV may update its driving context information and or update the requested maneuver at the maneuver negotiation state 804 based on the most restrictive suggestion(s) among the received sets of proposed modifications from the one or more RVs.

FIG. 8B is a functional block diagram illustrating an example architecture 800 for determining whether to transition from an awareness state 802 to a maneuver negotiation state 804, according to aspects of the disclosure. In some aspects, the architecture 800 may correspond to operations performed by a processing device onboard a vehicle (e.g., an HV).

In some aspects, an HV may obtain information 810 relevant to determining whether to transition from an awareness state to a negotiation state. In some aspects, the obtained information 810 may include the kinematic characteristics 812 of the HV. In some aspects, the kinematic characteristics of the HV may be obtained based measurements of the speed, position, and/or various measurements or readings of the powertrain of the HV. In some aspects, the obtained information 810 may include the environmental information 814 based on the ADAS or ADS and/or various sensors of the HV and/or based on information included in the received BSMs and/or other V2X messages. In some aspects, the obtained information 810 may include the input 816 from one or more sensing devices such as a radar, a lidar, and/or a camera of the HV. In some aspects, the input may indicate traffic conditions, a lane type, and/or a lane width as observed by the HV.

As shown in FIG. 8B, the HV may perform an MSF processing 820 using the obtained information 810 as input and generate an MSF 822 as an output. In some aspects, the MSF processing 820 may be based on a machine learning model (e.g., a neural network model). In some aspects, the machine learning model for the MSF processing 820 may be trained offline by the HV. In some aspects, the MSF processing 820 may be based on a non-machine learning based decision-making algorithm (e.g., including a set of equations and/or combination logics). In some aspects, the MSF processing 820 may be the same as, or a simplified version of, the first stage processing 720 when the HV is capable of engaging in another maneuver sharing and coordination session as an RV. In some aspects, the MSF processing 820 may infer or determine the MSF of the requested maneuver of the HV, where the MSF may indicate the probability of the requested maneuver of the HV being a safe lane change maneuver considering various factors based on the obtained information 810.

In some aspects, if the MSF indicates that a possible maneuver the HV intended to negotiate with one or more RVs may be an unsafe request (e.g., the MSF is equal to or less than a transition reference value), the HV may discard the possible maneuver and stay in the awareness state (e.g., decision 832). In some aspects, if the MSF indicates that the possible maneuver the HV intended to negotiate with one or more RVs may be not an unsafe request (e.g., the MSF is greater than a transition reference value), the HV may decide to transition to the maneuver negotiation state (e.g., decision 836) in order to proceed the maneuver sharing and coordination session based on operations illustrated in FIG. 5.

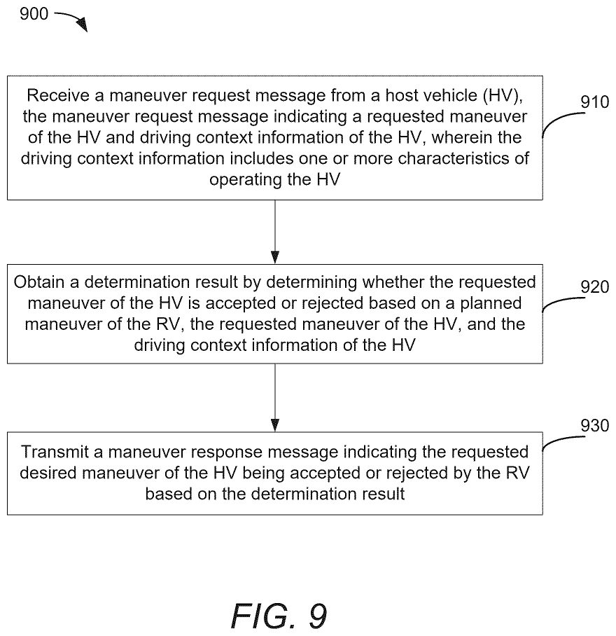

FIG. 9 is a flowchart illustrating an example method 900 of maneuver sharing and coordination performed by a processing device of a remote vehicle (RV), according to aspects of the disclosure. In some aspects, the processing device in the method 900 may correspond to the OBC 300 in FIG. 3, which may be onboard a vehicle (e.g., the RV 506 in FIG. 5). In some aspects, the method 900 may correspond to operations based on the example process flow 500 in FIG. 5 in view of the examples illustrated in FIGS. 6A-7.

In some aspects, the method 900 may be performed by the one or more WWAN transceivers 330, the one or more short-range transceivers 340, the one or more processors 306, the memory 304, and/or the maneuver sharing and coordination component 318, any or all of which may be considered means for performing one or more of the following operations of method 900.

At operation 910, the processing device on board an RV (e.g., the RV 506 in FIG. 5) may receive a maneuver request message from an HV (e.g., the HV 502 in FIG. 5). In some aspects, the maneuver request message may indicate a requested maneuver of the HV and driving context information of the HV. In some aspects, the driving context information may include one or more characteristics of operating the HV. In some aspects, operation 910 may be performed by the one or more WWAN transceivers 330, the one or more short-range transceivers 340, the one or more processors 306, the memory 304, and/or the maneuver sharing and coordination component 318, any or all of which may be considered means for performing operation 910.

In some aspects, the one or more characteristics of operating the HV may include a driver's profile, an autonomy level of the HV, an ASIL of the HV, or any combination thereof. In some aspects, the maneuver request message may have a format as illustrated in FIGS. 6A and 6B.

At operation 920, the processing device may obtain a determination result by determining whether the requested maneuver of the HV is accepted or rejected based on a planned maneuver of the RV, the requested maneuver of the HV, and the driving context information of the HV. In some aspects, the determination result may be based on the example architecture 700 in FIG. 7. In some aspects, operation 920 may be performed by the one or more WWAN transceivers 330, the one or more short-range transceivers 340, the one or more processors 306, the memory 304, and/or the maneuver sharing and coordination component 318, any or all of which may be considered means for performing operation 920.

In some aspects, the determination result may correspond to the requested maneuver of the HV is accepted by the RV, the requested maneuver of the HV is accepted by the RV with one or more proposed modifications, the requested maneuver of the HV is rejected by the RV with the one or more proposed modifications, or the requested maneuver of the HV is rejected by the RV. In some aspects, the one or more proposed modifications may include a proposed modification to the driving context information of the HV, a proposed modification to the requested maneuver of the HV, or both.

In some aspects, the processing device may determine whether the requested maneuver of the HV is accepted or rejected further based on driving context information of the RV. In some aspects, the processing device may determine whether the requested maneuver of the HV is accepted or rejected based on one or more machine learning models.

In some aspects, the processing device may determine whether the requested maneuver of the HV is accepted or rejected by determining a maneuver safety factor (MSF) associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and determining the requested maneuver of the HV is accepted based on the maneuver safety factor being greater than a reference value. In some aspects, the determining the maneuver safety factor may be based on a machine learning model.

In some aspects, the processing device may determine whether the requested maneuver of the HV is accepted or rejected further by determining, based on the maneuver safety factor being equal to or less than the reference value, whether the requested maneuver of the HV is rejected by the RV, accepted by the RV with one or more proposed modifications, rejected by the RV with the one or more proposed modifications, or rejected by the RV, based on the kinematics of the HV, the kinematics of the RV, the planned maneuver of the RV, the requested maneuver of the HV, the driving context information of the HV, the driving context information of the RV, the environmental condition, the one or more sensor inputs, or any combination thereof. In some aspects, the processing device may determine whether the requested maneuver of the HV is accepted by the RV with the one or more proposed modifications, rejected by the RV with the one or more proposed modifications, or rejected by the RV based on a machine learning model.

In some aspects, the maneuver response message may further request engaging in a raw sensor sharing session between the HV and the RV.

At operation 930, the processing device may transmit a maneuver response message indicating the requested maneuver of the HV being accepted or rejected by the RV (together with one or more proposed modifications, if applicable) based on the determination result. In some aspects, the maneuver response message may have a format as illustrated in FIGS. 6A and 6B. In some aspects, operation 930 may be performed by the one or more WWAN transceivers 330, the one or more short-range transceivers 340, the one or more processors 306, the memory 304, and/or the maneuver sharing and coordination component 318, any or all of which may be considered means for performing operation 930.

As will be appreciated, a technical advantage of the method 900 is, by engaging in a maneuver sharing and coordination session further based on the driving context information of the HV, an RV may better evaluate the requested maneuver and better respond the maneuver request message accordingly, and hence increase the overall driving safety and road safety. In some examples, by including the driving context information of the HV in the maneuver request message to one or more RVs, the RVs may determine whether to accept or reject a requested maneuver indicated by the maneuver request message further based on the driving context information of the HV. In some aspects, an RV may determine whether to provide one or more proposed modifications to the driving context information of the HV and/or the requested maneuver in order to improve the efficiency of the maneuver sharing and coordination session.

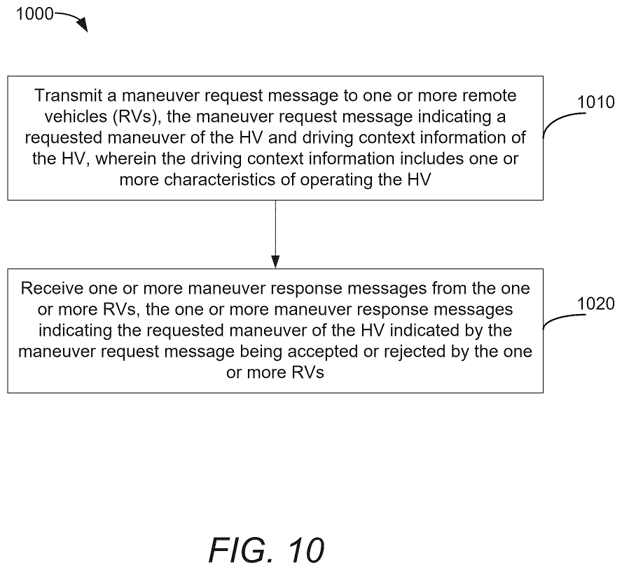

FIG. 10 is a flowchart illustrating an example method 1000 of maneuver sharing and coordination performed by a processing device of a host vehicle (HV), according to aspects of the disclosure. In some aspects, the processing device in the method 1000 may correspond to the OBC 300 in FIG. 3, which may be onboard a vehicle (e.g., the host vehicle (HV) 502 in FIG. 5. In some aspects, the method 1000 may correspond to operations based on the example process flow 500 in FIG. 5 in view of the examples illustrated in FIGS. 6A-6B and 8A-8B.

In some aspects, the method 1000 may be performed by the one or more WWAN transceivers 330, the one or more short-range transceivers 340, the one or more processors 306, the memory 304, and/or the maneuver sharing and coordination component 318, any or all of which may be considered means for performing one or more of the following operations of method 1000.

At operation 1010, the processing device on board an HV (e.g., the HV 502 in FIG. 5) may transmit a maneuver request message to one or more RVs (e.g., including the RV 506 in FIG. 5). In some aspects, the maneuver request message may indicate a requested maneuver of the HV and driving context information of the HV. In some aspects, the driving context information may include one or more characteristics of operating the HV. In some aspects, operation 1010 may be performed by the one or more WWAN transceivers 330, the one or more short-range transceivers 340, the one or more processors 306, the memory 304, and/or the maneuver sharing and coordination component 318, any or all of which may be considered means for performing operation 1010.

In some aspects, the one or more characteristics of operating the HV may include a driver's profile, an autonomy level of the HV, an ASIL of the HV, or any combination thereof. In some aspects, the maneuver request message may have a format as illustrated in FIGS. 6A and 6B.

At operation 1020, the processing device may receive one or more maneuver response messages from the one or more RVs. In some aspects, the one or more maneuver response messages may indicate the requested maneuver of the HV indicated by the maneuver request message being accepted or rejected by the one or more RVs (together with one or more proposed modifications, if applicable). In some aspects, the maneuver response message may have a format as illustrated in FIGS. 6A and 6B. In some aspects, operation 1020 may be performed by the one or more WWAN transceivers 330, the one or more short-range transceivers 340, the one or more processors 306, the memory 304, and/or the maneuver sharing and coordination component 318, any or all of which may be considered means for performing operation 1020.

In some aspects, at least one of the one or more maneuver response messages from a corresponding RV of the one or more RVs may indicate the requested maneuver of the HV is accepted by the RV, the requested maneuver of the HV is accepted by the RV with the one or more proposed modifications, the requested maneuver of the HV is rejected by the RV with the one or more proposed modifications, or the requested maneuver of the HV is rejected by the RV. In some aspects, the one or more proposed modifications may include a proposed modification to the driving context information of the HV, a proposed modification to the requested maneuver of the HV, or both.

In some aspects, the method 1000 may further include executing the requested maneuver of the HV indicated by the maneuver request message based on the one or more maneuver response messages indicating the requested maneuver of the HV indicated by the maneuver request message being accepted by the one or more RVs.

In some aspects, the one or more maneuver response messages may indicate that the requested maneuver of the HV is rejected by at least one of the one or more RVs. In some aspects, the method 1000 may further include transmitting a second maneuver request message to the one or more RVs. In some aspects, the second maneuver request message may indicate an updated requested maneuver of the HV and the driving context information of the HV, the requested maneuver of the HV and updated driving context information of the HV, or the updated requested maneuver of the HV and the updated driving context information of the HV. In some aspects, the method 1000 may further include receiving second one or more maneuver response messages from the one or more RVs. In some aspects, the second one or more maneuver response messages may indicate the requested maneuver of the HV or the updated requested maneuver of the HV indicated by the second maneuver request message being accepted or rejected by the one or more RVs.

In some aspects, the one or more maneuver response messages may indicate one or more proposed modifications to the driving context information of the HV, one or more proposed modifications to the requested maneuver of the HV, or both. In some aspects, the updated requested maneuver of the HV may be based on the one or more proposed modifications to the requested maneuver of the HV; or the updated driving context information of the HV may be based on the one or more proposed modifications to the driving context information of the HV; or both.

In some aspects, the updated requested maneuver of the HV may satisfy all restrictions based on the one or more proposed modifications to the requested maneuver of the HV; or the updated driving context information of the HV may satisfy all restrictions based on the one or more proposed modifications to the driving context information of the HV; or both.

In some aspects, the method 1000 may further include executing the requested maneuver of the HV or the updated requested maneuver of the HV indicated by the second maneuver request message based on the second one or more maneuver response messages indicating the requested maneuver of the HV or the updated requested maneuver of the HV indicated by the second maneuver request message being accepted by the one or more RVs.

In some aspects, the method 1000 may further include determining a maneuver safety factor (MSF) associated with the requested maneuver of the HV based on kinematics of the HV, the requested maneuver of the HV, an environmental condition, one or more sensor inputs, or any combination thereof. In some aspects, the processing device may transmit the maneuver request message to the one or more RVs based on the maneuver safety factor is greater than a reference value for maneuver negotiation.

In some aspects, at least one of the one or more maneuver response messages from a corresponding RV of the one or more RVs may request engaging in a raw sensor sharing session between the HV and the corresponding RV.

As will be appreciated, a technical advantage of the method 1000 is, by engaging in a maneuver sharing and coordination session further based on the driving context information of the HV, an RV may better evaluate the requested maneuver and better respond the maneuver request message accordingly, and hence increase the overall driving safety and road safety. In some examples, by including the driving context information of the HV in the maneuver request message to one or more RVs, the RVs may determine whether to accept or reject a requested maneuver indicated by the maneuver request message further based on the driving context information of the HV. In some aspects, the HV may receive from the RVs one or more proposed modifications to the driving context information of the HV and/or the requested maneuver and update the requested maneuver and/or driving context information accordingly, in order to improve the efficiency of the maneuver sharing and coordination session.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of maneuver sharing and coordination performed by a processing device of a remote vehicle (RV), the method comprising: receiving a maneuver request message from a host vehicle (HV), the maneuver request message indicating a requested maneuver of the HV and driving context information of the HV, wherein the driving context information includes one or more characteristics of operating the HV; obtaining a determination result by determining whether the requested maneuver of the HV is accepted or rejected based on a planned maneuver of the RV, the requested maneuver of the HV, and the driving context information of the HV; and transmitting a maneuver response message indicating the requested maneuver of the HV being accepted or rejected by the RV based on the determination result.

Clause 2. The method of clause 1, wherein the one or more characteristics of operating the HV comprise: a driver's profile; an autonomy level of the HV; an automotive safety integrity level (ASIL) of the HV; or any combination thereof.

Clause 3. The method of any of clauses 1 to 2, wherein the determination result corresponds to: the requested maneuver of the HV is accepted by the RV; the requested maneuver of the HV is accepted by the RV with one or more proposed modifications; the requested maneuver of the HV is rejected by the RV with the one or more proposed modifications; or the requested maneuver of the HV is rejected by the RV.

Clause 4. The method of clause 3, wherein the one or more proposed modifications comprise: a proposed modification to the driving context information of the HV; a proposed modification to the requested maneuver of the HV; or both.

Clause 5. The method of any of clauses 1 to 4, wherein: the determining whether the requested maneuver of the HV is accepted or rejected is further based on driving context information of the RV.

Clause 6. The method of any of clauses 1 to 5, wherein: the determining whether the requested maneuver of the HV is accepted or rejected is based on one or more machine learning models.

Clause 7. The method of any of clauses 1 to 6, wherein the determining whether the requested maneuver of the HV is accepted or rejected comprises: determining a maneuver safety factor associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and determining the requested maneuver of the HV is accepted based on the maneuver safety factor being greater than a reference value.

Clause 8. The method of clause 7, wherein the determining the maneuver safety factor is based on a machine learning model.

Clause 9. The method of any of clauses 7 to 8, wherein the determining whether the requested maneuver of the HV is accepted or rejected further comprises: determining, based on the maneuver safety factor being equal to or less than the reference value, whether the requested maneuver of the HV is rejected by the RV, accepted by the RV with one or more proposed modifications, rejected by the RV with the one or more proposed modifications, or rejected by the RV, based on the kinematics of the HV, the kinematics of the RV, the planned maneuver of the RV, the requested maneuver of the HV, the driving context information of the HV, the driving context information of the RV, the environmental condition, the one or more sensor inputs, or any combination thereof.

Clause 10. The method of clause 9, wherein the determining whether the requested maneuver of the HV is accepted by the RV with the one or more proposed modifications, rejected by the RV with the one or more proposed modifications, or rejected by the RV is based on a machine learning model.

Clause 11. The method of any of clauses 1 to 10, wherein: the maneuver response message further requests engaging in a raw sensor sharing session between the HV and the RV.

Clause 12. A method of maneuver sharing and coordination performed by a processing device of a host vehicle (HV), the method comprising: transmitting a maneuver request message to one or more remote vehicles (RVs), the maneuver request message indicating a requested maneuver of the HV and driving context information of the HV, wherein the driving context information includes one or more characteristics of operating the HV; and receiving one or more maneuver response messages from the one or more RVs, the one or more maneuver response messages indicating the requested maneuver of the HV indicated by the maneuver request message being accepted or rejected by the one or more RVs.

Clause 13. The method of clause 12, further comprising: executing the requested maneuver of the HV indicated by the maneuver request message based on the one or more maneuver response messages indicating the requested maneuver of the HV indicated by the maneuver request message being accepted by the one or more RVs.

Clause 14. The method of any of clauses 12 to 13, wherein the one or more characteristics of operating the HV comprise: a driver's profile; an autonomy level of the HV; an automotive safety integrity level (ASIL) of the HV; or any combination thereof.

Clause 15. The method of any of clauses 12 to 14, wherein at least one of the one or more maneuver response messages from a corresponding RV of the one or more RVs indicates: the requested maneuver of the HV is accepted by the corresponding RV; the requested maneuver of the HV is accepted by the corresponding RV with one or more proposed modifications; the requested maneuver of the HV is rejected by the corresponding RV with the one or more proposed modifications; or the requested maneuver of the HV is rejected by the corresponding RV.

Clause 16. The method of clause 15, wherein the one or more proposed modifications comprise: a proposed modification to the driving context information of the HV; a proposed modification to the requested maneuver of the HV; or both.

Clause 17. The method of any of clauses 12 to 16, wherein: the one or more maneuver response messages indicates that the requested maneuver of the HV is rejected by at least one of the one or more RVs, and the method further comprises: transmitting a second maneuver request message to the one or more RVs, the second maneuver request message indicating receiving second one or more maneuver response messages from the one or more RVs, the second one or more maneuver response messages indicating the requested maneuver of the HV or the updated requested maneuver of the HV indicated by the second maneuver request message being accepted or rejected by the one or more RVs.

Clause 18. The method of clause 17, wherein the one or more maneuver response messages indicate one or more proposed modifications to the driving context information of the HV, one or more proposed modifications to the requested maneuver of the HV, or both, and wherein: the updated requested maneuver of the HV is based on the one or more proposed modifications to the requested maneuver of the HV, the updated driving context information of the HV is based on the one or more proposed modifications to the driving context information of the HV, or both.

Clause 19. The method of clause 18, wherein: the updated requested maneuver of the HV satisfies all restrictions based on the one or more proposed modifications to the requested maneuver of the HV, the updated driving context information of the HV satisfies all restrictions based on the one or more proposed modifications to the driving context information of the HV, or both.

Clause 20. The method of any of clauses 17 to 19, further comprising: executing the requested maneuver of the HV or the updated requested maneuver of the HV indicated by the maneuver request message based on the second one or more maneuver response messages indicating the requested maneuver of the HV or the updated requested maneuver of the HV indicated by the second maneuver request message being accepted by the one or more RVs.

Clause 21. The method of any of clauses 12 to 20, further comprising: determining a maneuver safety factor associated with the requested maneuver of the HV based on kinematics of the HV, the requested maneuver of the HV, an environmental condition, one or more sensor inputs, or any combination thereof, wherein the transmitting the maneuver request message to the one or more RVs is performed based on the maneuver safety factor is greater than a reference value for maneuver negotiation.

Clause 22. The method of any of clauses 12 to 21, wherein: at least one of the one or more maneuver response messages from a corresponding RV of the one or more RVs requests engaging in a raw sensor sharing session between the HV and the corresponding RV.

Clause 23. A processing device of a remote vehicle (RV), comprising: one or more memories; one or more transceivers; and one or more processors communicatively coupled to the one or more memories and the one or more transceivers, the one or more processors, either alone or in combination, configured to: receive, via the one or more transceivers, a maneuver request message from a host vehicle (HV), the maneuver request message indicating a requested maneuver of the HV and driving context information of the HV, wherein the driving context information includes one or more characteristics of operating the HV; obtain a determination result by determining whether the requested maneuver of the HV is accepted or rejected based on a planned maneuver of the RV, the requested maneuver of the HV, and the driving context information of the HV; and transmit, via the one or more transceivers, a maneuver response message indicating the requested maneuver of the HV being accepted or rejected by the RV based on the determination result.

Clause 24. The processing device of clause 23, wherein the one or more characteristics of operating the HV comprise: a driver's profile; an autonomy level of the HV; an automotive safety integrity level (ASIL) of the HV; or any combination thereof.

Clause 25. The processing device of any of clauses 23 to 24, wherein the determination result corresponds to: the requested maneuver of the HV is accepted by the RV; the requested maneuver of the HV is accepted by the RV with one or more proposed modifications; the requested maneuver of the HV is rejected by the RV with the one or more proposed modifications; or the requested maneuver of the HV is rejected by the RV.

Clause 26. The processing device of clause 25, wherein the one or more proposed modifications comprise: a proposed modification to the driving context information of the HV; a proposed modification to the requested maneuver of the HV; or both.

Clause 27. The processing device of any of clauses 23 to 26, wherein: the determining whether the requested maneuver of the HV is accepted or rejected is further based on driving context information of the RV.

Clause 28. The processing device of any of clauses 23 to 27, wherein: the determining whether the requested maneuver of the HV is accepted or rejected is based on one or more machine learning models.

Clause 29. The processing device of any of clauses 23 to 28, wherein the determining whether the requested maneuver of the HV is accepted or rejected comprises: determine a maneuver safety factor associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and determine the requested maneuver of the HV is accepted based on the maneuver safety factor being greater than a reference value.

Clause 30. The processing device of clause 29, wherein the determining the maneuver safety factor is based on a machine learning model.

Clause 31. The processing device of any of clauses 29 to 30, wherein the determining whether the requested maneuver of the HV is accepted or rejected further comprises: determine, based on the maneuver safety factor being equal to or less than the reference value, whether the requested maneuver of the HV is reject by the RV, accept by the RV with one or more proposed modifications, reject by the RV with the one or more proposed modifications, or reject by the RV, based on the kinematics of the HV, the kinematics of the RV, the planned maneuver of the RV, the requested maneuver of the HV, the driving context information of the HV, the driving context information of the RV, the environmental condition, the one or more sensor inputs, or any combination thereof.

Clause 32. The processing device of clause 31, wherein the determining whether the requested maneuver of the HV is accepted by the RV with the one or more proposed modifications, rejected by the RV with the one or more proposed modifications, or rejected by the RV is based on a machine learning model.

Clause 33. The processing device of any of clauses 23 to 32, wherein: the maneuver response message further requests engaging in a raw sensor sharing session between the HV and the RV.

Clause 34. A processing device of a host vehicle (HV), comprising: one or more memories; one or more transceivers; and one or more processors communicatively coupled to the one or more memories and the one or more transceivers, the one or more processors, either alone or in combination, configured to: transmit, via the one or more transceivers, a maneuver request message to one or more remote vehicles (RVs), the maneuver request message indicating a requested maneuver of the HV and driving context information of the HV, wherein the driving context information includes one or more characteristics of operating the HV; and receive, via the one or more transceivers, one or more maneuver response messages from the one or more RVs, the one or more maneuver response messages indicating the requested maneuver of the HV indicated by the maneuver request message being accepted or rejected by the one or more RVs.

Clause 35. The processing device of clause 34, wherein the one or more processors, either alone or in combination, are further configured to: execute the requested maneuver of the HV indicated by the maneuver request message based on the one or more maneuver response messages indicating the requested maneuver of the HV indicated by the maneuver request message being accepted by the one or more RVs.

Clause 36. The processing device of any of clauses 34 to 35, wherein the one or more characteristics of operating the HV comprise: a driver's profile; an autonomy level of the HV; an automotive safety integrity level (ASIL) of the HV; or any combination thereof.

Clause 37. The processing device of any of clauses 34 to 36, wherein at least one of the one or more maneuver response messages from a corresponding RV of the one or more RVs indicates: the requested maneuver of the HV is accepted by the corresponding RV; the requested maneuver of the HV is accepted by the corresponding RV with one or more proposed modifications; the requested maneuver of the HV is rejected by the corresponding RV with the one or more proposed modifications; or the requested maneuver of the HV is rejected by the corresponding RV.

Clause 38. The processing device of clause 37, wherein the one or more proposed modifications comprise: a proposed modification to the driving context information of the HV; a proposed modification to the requested maneuver of the HV; or both.

Clause 39. The processing device of any of clauses 34 to 38, wherein: the one or more maneuver response messages indicates that the requested maneuver of the HV is rejected by at least one of the one or more RVs, and the method further comprises: transmit, via the one or more transceivers, a second maneuver request message to the one or more RVs, the second maneuver request message indicating receive, via the one or more transceivers, second one or more maneuver response messages from the one or more RVs, the second one or more maneuver response messages indicating the requested maneuver of the HV or the updated requested maneuver of the HV indicated by the second maneuver request message being accepted or rejected by the one or more RVs.

Clause 40. The processing device of clause 39, wherein the one or more maneuver response messages indicate one or more proposed modifications to the driving context information of the HV, one or more proposed modifications to the requested maneuver of the HV, or both, and: the updated requested maneuver of the HV is based on the one or more proposed modifications to the requested maneuver of the HV, the updated driving context information of the HV is based on the one or more proposed modifications to the driving context information of the HV, or both.

Clause 41. The processing device of clause 40, wherein: the updated requested maneuver of the HV satisfies all restrictions based on the one or more proposed modifications to the requested maneuver of the HV, the updated driving context information of the HV satisfies all restrictions based on the one or more proposed modifications to the driving context information of the HV, or both.

Clause 42. The processing device of any of clauses 39 to 41, wherein the one or more processors, either alone or in combination, are further configured to: execute the requested maneuver of the HV or the updated requested maneuver of the HV indicated by the maneuver request message based on the second one or more maneuver response messages indicating the requested maneuver of the HV or the updated requested maneuver of the HV indicated by the second maneuver request message being accepted by the one or more RVs.

Clause 43. The processing device of any of clauses 34 to 42, wherein the one or more processors, either alone or in combination, are further configured to: determine a maneuver safety factor associated with the requested maneuver of the HV based on kinematics of the HV, the requested maneuver of the HV, an environmental condition, one or more sensor inputs, or any combination thereof, wherein the transmitting the maneuver request message to the one or more RVs is performed based on the maneuver safety factor is greater than a reference value for maneuver negotiation.

Clause 44. The processing device of any of clauses 34 to 43, wherein: at least one of the one or more maneuver response messages from a corresponding RV of the one or more RVs requests engaging in a raw sensor sharing session between the HV and the corresponding RV.

Clause 45. A processing device of a remote vehicle (RV), comprising: means for receiving a maneuver request message from a host vehicle (HV), the maneuver request message indicating a requested maneuver of the HV and driving context information of the HV, wherein the driving context information includes one or more characteristics of operating the HV; means for obtaining a determination result by determining whether the requested maneuver of the HV is accepted or rejected based on a planned maneuver of the RV, the requested maneuver of the HV, and the driving context information of the HV; and means for transmitting a maneuver response message indicating the requested maneuver of the HV being accepted or rejected by the RV based on the determination result.

Clause 46. The processing device of clause 45, wherein the one or more characteristics of operating the HV comprise: a driver's profile; an autonomy level of the HV; an automotive safety integrity level (ASIL) of the HV; or any combination thereof.

Clause 47. The processing device of any of clauses 45 to 46, wherein the determination result corresponds to: the requested maneuver of the HV is accepted by the RV; the requested maneuver of the HV is accepted by the RV with one or more proposed modifications; the requested maneuver of the HV is rejected by the RV with the one or more proposed modifications; or the requested maneuver of the HV is rejected by the RV.

Clause 48. The processing device of clause 47, wherein the one or more proposed modifications comprise: a proposed modification to the driving context information of the HV; a proposed modification to the requested maneuver of the HV; or both.

Clause 49. The processing device of any of clauses 45 to 48, wherein: the determining whether the requested maneuver of the HV is accepted or rejected is further based on driving context information of the RV.

Clause 50. The processing device of any of clauses 45 to 49, wherein: the determining whether the requested maneuver of the HV is accepted or rejected is based on one or more machine learning models.

Clause 51. The processing device of any of clauses 45 to 50, wherein the determining whether the requested maneuver of the HV is accepted or rejected comprises: means for determining a maneuver safety factor associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and means for determining the requested maneuver of the HV is accepted based on the maneuver safety factor being greater than a reference value.

Clause 52. The processing device of clause 51, wherein the determining the maneuver safety factor is based on a machine learning model.

Clause 53. The processing device of any of clauses 51 to 52, wherein the determining whether the requested maneuver of the HV is accepted or rejected further comprises: means for determining, based on the maneuver safety factor being equal to or less than the reference value, whether the requested maneuver of the HV is means for rejecting by the RV, means for accepting by the RV with one or more proposed modifications, means for rejecting by the RV with the one or more proposed modifications, or means for rejecting by the RV, based on the kinematics of the HV, the kinematics of the RV, the planned maneuver of the RV, the requested maneuver of the HV, the driving context information of the HV, the driving context information of the RV, the environmental condition, the one or more sensor inputs, or any combination thereof.

Clause 54. The processing device of clause 53, wherein the determining whether the requested maneuver of the HV is accepted by the RV with the one or more proposed modifications, rejected by the RV with the one or more proposed modifications, or rejected by the RV is based on a machine learning model.

Clause 55. The processing device of any of clauses 45 to 54, wherein: the maneuver response message further requests engaging in a raw sensor sharing session between the HV and the RV.

Clause 56. A processing device of a host vehicle (HV), comprising: means for transmitting a maneuver request message to one or more remote vehicles (RVs), the maneuver request message indicating a requested maneuver of the HV and driving context information of the HV, wherein the driving context information includes one or more characteristics of operating the HV; and means for receiving one or more maneuver response messages from the one or more RVs, the one or more maneuver response messages indicating the requested maneuver of the HV indicated by the maneuver request message being accepted or rejected by the one or more RVs.

Clause 57. The processing device of clause 56, further comprising: means for executing the requested maneuver of the HV indicated by the maneuver request message based on the one or more maneuver response messages indicating the requested maneuver of the HV indicated by the maneuver request message being accepted by the one or more RVs.

Clause 58. The processing device of any of clauses 56 to 57, wherein the one or more characteristics of operating the HV comprise: a driver's profile; an autonomy level of the HV; an automotive safety integrity level (ASIL) of the HV; or any combination thereof.

Clause 59. The processing device of any of clauses 56 to 58, wherein at least one of the one or more maneuver response messages from a corresponding RV of the one or more RVs indicates: the requested maneuver of the HV is accepted by the corresponding RV; the requested maneuver of the HV is accepted by the corresponding RV with one or more proposed modifications; the requested maneuver of the HV is rejected by the corresponding RV with the one or more proposed modifications; or the requested maneuver of the HV is rejected by the corresponding RV.

Clause 60. The processing device of clause 59, wherein the one or more proposed modifications comprise: a proposed modification to the driving context information of the HV; a proposed modification to the requested maneuver of the HV; or both.

Clause 61. The processing device of any of clauses 56 to 60, wherein: the one or more maneuver response messages indicates that the requested maneuver of the HV is rejected by at least one of the one or more RVs, and the method further comprises: means for transmitting a second maneuver request message to the one or more RVs, the second maneuver request message indicating means for receiving second one or more maneuver response messages from the one or more RVs, the second one or more maneuver response messages indicating the requested maneuver of the HV or the updated requested maneuver of the HV indicated by the second maneuver request message being accepted or rejected by the one or more RVs.

Clause 62. The processing device of clause 61, wherein the one or more maneuver response messages indicate one or more proposed modifications to the driving context information of the HV, one or more proposed modifications to the requested maneuver of the HV, or both, and means for: the updated requested maneuver of the HV is based on the one or more proposed modifications to the requested maneuver of the HV, the updated driving context information of the HV is based on the one or more proposed modifications to the driving context information of the HV, or both.

Clause 63. The processing device of clause 62, wherein: the updated requested maneuver of the HV satisfies all restrictions based on the one or more proposed modifications to the requested maneuver of the HV, the updated driving context information of the HV satisfies all restrictions based on the one or more proposed modifications to the driving context information of the HV, or both.

Clause 64. The processing device of any of clauses 61 to 63, further comprising: means for executing the requested maneuver of the HV or the updated requested maneuver of the HV indicated by the maneuver request message based on the second one or more maneuver response messages indicating the requested maneuver of the HV or the updated requested maneuver of the HV indicated by the second maneuver request message being accepted by the one or more RVs.

Clause 65. The processing device of any of clauses 56 to 64, further comprising: means for determining a maneuver safety factor associated with the requested maneuver of the HV based on kinematics of the HV, the requested maneuver of the HV, an environmental condition, one or more sensor inputs, or any combination thereof, wherein the transmitting the maneuver request message to the one or more RVs is performed based on the maneuver safety factor is greater than a reference value for maneuver negotiation.

Clause 66. The processing device of any of clauses 56 to 65, wherein: at least one of the one or more maneuver response messages from a corresponding RV of the one or more RVs requests engaging in a raw sensor sharing session between the HV and the corresponding RV.

Clause 67. A non-transitory computer-readable medium storing computer-executable instructions that, when executed by a processing device of a remote vehicle (RV), cause the processing device to: receive a maneuver request message from a host vehicle (HV), the maneuver request message indicating a requested maneuver of the HV and driving context information of the HV, wherein the driving context information includes one or more characteristics of operating the HV; obtain a determination result by determining whether the requested maneuver of the HV is accepted or rejected based on a planned maneuver of the RV, the requested maneuver of the HV, and the driving context information of the HV; and transmit a maneuver response message indicating the requested maneuver of the HV being accepted or rejected by the RV based on the determination result.

Clause 68. The non-transitory computer-readable medium of clause 67, wherein the one or more characteristics of operating the HV comprise: a driver's profile; an autonomy level of the HV; an automotive safety integrity level (ASIL) of the HV; or any combination thereof.

Clause 69. The non-transitory computer-readable medium of any of clauses 67 to 68, wherein the determination result corresponds to: the requested maneuver of the HV is accepted by the RV; the requested maneuver of the HV is accepted by the RV with one or more proposed modifications; the requested maneuver of the HV is rejected by the RV with the one or more proposed modifications; or the requested maneuver of the HV is rejected by the RV.

Clause 70. The non-transitory computer-readable medium of clause 69, wherein the one or more proposed modifications comprise: a proposed modification to the driving context information of the HV; a proposed modification to the requested maneuver of the HV; or both.

Clause 71. The non-transitory computer-readable medium of any of clauses 67 to 70, wherein: the determining whether the requested maneuver of the HV is accepted or rejected is further based on driving context information of the RV.

Clause 72. The non-transitory computer-readable medium of any of clauses 67 to 71, wherein: the determining whether the requested maneuver of the HV is accepted or rejected is based on one or more machine learning models.

Clause 73. The non-transitory computer-readable medium of any of clauses 67 to 72, wherein the determining whether the requested maneuver of the HV is accepted or rejected comprises: determine a maneuver safety factor associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and determine the requested maneuver of the HV is accepted based on the maneuver safety factor being greater than a reference value.

Clause 74. The non-transitory computer-readable medium of clause 73, wherein the determining the maneuver safety factor is based on a machine learning model.

Clause 75. The non-transitory computer-readable medium of any of clauses 73 to 74, wherein the determining whether the requested maneuver of the HV is accepted or rejected further comprises: determine, based on the maneuver safety factor being equal to or less than the reference value, whether the requested maneuver of the HV is reject by the RV, accept by the RV with one or more proposed modifications, reject by the RV with the one or more proposed modifications, or reject by the RV, based on the kinematics of the HV, the kinematics of the RV, the planned maneuver of the RV, the requested maneuver of the HV, the driving context information of the HV, the driving context information of the RV, the environmental condition, the one or more sensor inputs, or any combination thereof.

Clause 76. The non-transitory computer-readable medium of clause 75, wherein the determining whether the requested maneuver of the HV is accepted by the RV with the one or more proposed modifications, rejected by the RV with the one or more proposed modifications, or rejected by the RV is based on a machine learning model.

Clause 77. The non-transitory computer-readable medium of any of clauses 67 to 76, wherein: the maneuver response message further requests engaging in a raw sensor sharing session between the HV and the RV.

Clause 78. A non-transitory computer-readable medium storing computer-executable instructions that, when executed by a processing device of a host vehicle (HV), cause the processing device to: transmit a maneuver request message to one or more remote vehicles (RVs), the maneuver request message indicating a requested maneuver of the HV and driving context information of the HV, wherein the driving context information includes one or more characteristics of operating the HV; and receive one or more maneuver response messages from the one or more RVs, the one or more maneuver response messages indicating the requested maneuver of the HV indicated by the maneuver request message being accepted or rejected by the one or more RVs.

Clause 79. The non-transitory computer-readable medium of clause 78, further comprising computer-executable instructions that, when executed by the processing device, cause the processing device to: execute the requested maneuver of the HV indicated by the maneuver request message based on the one or more maneuver response messages indicating the requested maneuver of the HV indicated by the maneuver request message being accepted by the one or more RVs.

Clause 80. The non-transitory computer-readable medium of any of clauses 78 to 79, wherein the one or more characteristics of operating the HV comprise: a driver's profile; an autonomy level of the HV; an automotive safety integrity level (ASIL) of the HV; or any combination thereof.

Clause 81. The non-transitory computer-readable medium of any of clauses 78 to 80, wherein at least one of the one or more maneuver response messages from a corresponding RV of the one or more RVs indicates: the requested maneuver of the HV is accepted by the corresponding RV; the requested maneuver of the HV is accepted by the corresponding RV with one or more proposed modifications; the requested maneuver of the HV is rejected by the corresponding RV with the one or more proposed modifications; or the requested maneuver of the HV is rejected by the corresponding RV.

Clause 82. The non-transitory computer-readable medium of any of clauses 80 to 81, wherein the one or more proposed modifications comprise: a proposed modification to the driving context information of the HV; a proposed modification to the requested maneuver of the HV; or both.

Clause 83. The non-transitory computer-readable medium of any of clauses 78 to 82, wherein: the one or more maneuver response messages indicates that the requested maneuver of the HV is rejected by at least one of the one or more RVs, and the method further comprises: transmit a second maneuver request message to the one or more RVs, the second maneuver request message indicating receive second one or more maneuver response messages from the one or more RVs, the second one or more maneuver response messages indicating the requested maneuver of the HV or the updated requested maneuver of the HV indicated by the second maneuver request message being accepted or rejected by the one or more RVs.

Clause 84. The non-transitory computer-readable medium of any of clauses 82 to 83, wherein the one or more maneuver response messages indicate one or more proposed modifications to the driving context information of the HV, one or more proposed modifications to the requested maneuver of the HV, or both, and: the updated requested maneuver of the HV is based on the one or more proposed modifications to the requested maneuver of the HV, the updated driving context information of the HV is based on the one or more proposed modifications to the driving context information of the HV, or both.

Clause 85. The non-transitory computer-readable medium of any of clauses 83 to 84, wherein: the updated requested maneuver of the HV satisfies all restrictions based on the one or more proposed modifications to the requested maneuver of the HV, the updated driving context information of the HV satisfies all restrictions based on the one or more proposed modifications to the driving context information of the HV, or both.

Clause 86. The non-transitory computer-readable medium of any of clauses 82 to 85, further comprising computer-executable instructions that, when executed by the processing device, cause the processing device to: execute the requested maneuver of the HV or the updated requested maneuver of the HV indicated by the maneuver request message based on the second one or more maneuver response messages indicating the requested maneuver of the HV or the updated requested maneuver of the HV indicated by the second maneuver request message being accepted by the one or more RVs.

Clause 87. The non-transitory computer-readable medium of any of clauses 78 to 86, further comprising computer-executable instructions that, when executed by the processing device, cause the processing device to: determine a maneuver safety factor associated with the requested maneuver of the HV based on kinematics of the HV, the requested maneuver of the HV, an environmental condition, one or more sensor inputs, or any combination thereof, wherein the transmitting the maneuver request message to the one or more RVs is performed based on the maneuver safety factor is greater than a reference value for maneuver negotiation.

Clause 88. The non-transitory computer-readable medium of any of clauses 78 to 87, wherein: at least one of the one or more maneuver response messages from a corresponding RV of the one or more RVs requests engaging in a raw sensor sharing session between the HV and the corresponding RV.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of maneuver sharing and coordination performed by a processing device of a remote vehicle (RV), the method comprising:
receiving a maneuver request message from a host vehicle (HV), the maneuver request message indicating a requested maneuver of the HV and driving context information of the HV, wherein the driving context information includes one or more characteristics of operating the HV;
obtaining a determination result by determining whether the requested maneuver of the HV is accepted or rejected based on a planned maneuver of the RV, the requested maneuver of the HV, and the driving context information of the HV; and
transmitting a maneuver response message indicating the requested maneuver of the HV being accepted or rejected by the RV based on the determination result.

2. The method of claim 1, wherein the one or more characteristics of operating the HV comprise:
a driver's profile;
an autonomy level of the HV;
an automotive safety integrity level (ASIL) of the HV; or
any combination thereof.

3. The method of claim 1, wherein the determination result corresponds to:
the requested maneuver of the HV is accepted by the RV;
the requested maneuver of the HV is accepted by the RV with one or more proposed modifications;
the requested maneuver of the HV is rejected by the RV with the one or more proposed modifications; or
the requested maneuver of the HV is rejected by the RV.

4. The method of claim 3, wherein the one or more proposed modifications comprise:
a proposed modification to the driving context information of the HV;
a proposed modification to the requested maneuver of the HV; or
both.

5. The method of claim 1, wherein:
the determining whether the requested maneuver of the HV is accepted or rejected is further based on driving context information of the RV.

6. The method of claim 1, wherein:
the determining whether the requested maneuver of the HV is accepted or rejected is based on one or more machine learning models.

7. The method of claim 1, wherein the determining whether the requested maneuver of the HV is accepted or rejected comprises:
determining a maneuver safety factor associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and
determining the requested maneuver of the HV is accepted based on the maneuver safety factor being greater than a reference value.

8. The method of claim 7, wherein the determining the maneuver safety factor is based on a machine learning model.

9. The method of claim 7, wherein the determining whether the requested maneuver of the HV is accepted or rejected further comprises:
determining, based on the maneuver safety factor being equal to or less than the reference value, whether the requested maneuver of the HV is
rejected by the RV,
accepted by the RV with one or more proposed modifications,
rejected by the RV with the one or more proposed modifications, or
rejected by the RV,
based on the kinematics of the HV, the kinematics of the RV, the planned maneuver of the RV, the requested maneuver of the HV, the driving context information of the HV, the driving context information of the RV, the environmental condition, the one or more sensor inputs, or any combination thereof.

10. The method of claim 9, wherein the determining whether the requested maneuver of the HV is accepted by the RV with the one or more proposed modifications, rejected by the RV with the one or more proposed modifications, or rejected by the RV is based on a machine learning model.

11. The method of claim 1, wherein:
the maneuver response message further requests engaging in a raw sensor sharing session between the HV and the RV.

12. A method of maneuver sharing and coordination performed by a processing device of a host vehicle (HV), the method comprising:
transmitting a maneuver request message to one or more remote vehicles (RVs), the maneuver request message indicating a requested maneuver of the HV and driving context information of the HV, wherein the driving context information includes one or more characteristics of operating the HV; and
receiving one or more maneuver response messages from the one or more RVs, the one or more maneuver response messages indicating the requested maneuver of the HV indicated by the maneuver request message being accepted or rejected by the one or more RVs.

13. The method of claim 12, further comprising:
executing the requested maneuver of the HV indicated by the maneuver request message based on the one or more maneuver response messages indicating the requested maneuver of the HV indicated by the maneuver request message being accepted by the one or more RVs.

14. The method of claim 12, wherein the one or more characteristics of operating the HV comprise:
a driver's profile;
an autonomy level of the HV;
an automotive safety integrity level (ASIL) of the HV; or
any combination thereof.

15. The method of claim 12, wherein at least one of the one or more maneuver response messages from a corresponding RV of the one or more RVs indicates:
the requested maneuver of the HV is accepted by the corresponding RV;
the requested maneuver of the HV is accepted by the corresponding RV with one or more proposed modifications;
the requested maneuver of the HV is rejected by the corresponding RV with the one or more proposed modifications; or
the requested maneuver of the HV is rejected by the corresponding RV.

16. The method of claim 15, wherein the one or more proposed modifications comprise:
a proposed modification to the driving context information of the HV;
a proposed modification to the requested maneuver of the HV; or
both.

17. The method of claim 12, wherein:
the one or more maneuver response messages indicates that the requested maneuver of the HV is rejected by at least one of the one or more RVs, and
the method further comprises:
transmitting a second maneuver request message to the one or more RVs, the second maneuver request message indicating
an updated requested maneuver of the HV and the driving context information of the HV,
the requested maneuver of the HV and updated driving context information of the HV, or
the updated requested maneuver of the HV and the updated driving context information of the HV; and
receiving second one or more maneuver response messages from the one or more RVs, the second one or more maneuver response messages indicating the requested maneuver of the HV or the updated requested maneuver of the HV indicated by the second maneuver request message being accepted or rejected by the one or more RVs.

18. The method of claim 17,
wherein the one or more maneuver response messages indicate one or more proposed modifications to the driving context information of the HV, one or more proposed modifications to the requested maneuver of the HV, or both, and
wherein:
the updated requested maneuver of the HV is based on the one or more proposed modifications to the requested maneuver of the HV,
the updated driving context information of the HV is based on the one or more proposed modifications to the driving context information of the HV, or
both.

19. The method of claim 18, wherein:
the updated requested maneuver of the HV satisfies all restrictions based on the one or more proposed modifications to the requested maneuver of the HV,
the updated driving context information of the HV satisfies all restrictions based on the one or more proposed modifications to the driving context information of the HV, or
both.

20. The method of claim 17, further comprising:
executing the requested maneuver of the HV or the updated requested maneuver of the HV indicated by the maneuver request message based on the second one or more maneuver response messages indicating the requested maneuver of the HV or the updated requested maneuver of the HV indicated by the second maneuver request message being accepted by the one or more RVs.

21. The method of claim 12, further comprising:
determining a maneuver safety factor associated with the requested maneuver of the HV based on kinematics of the HV, the requested maneuver of the HV, an environmental condition, one or more sensor inputs, or any combination thereof,
wherein the transmitting the maneuver request message to the one or more RVs is performed based on the maneuver safety factor is greater than a reference value for maneuver negotiation.

22. The method of claim 12, wherein:
at least one of the one or more maneuver response messages from a corresponding RV of the one or more RVs requests engaging in a raw sensor sharing session between the HV and the corresponding RV.

23. A processing device of a remote vehicle (RV), comprising:
one or more memories;
one or more transceivers; and
one or more processors communicatively coupled to the one or more memories and the one or more transceivers, the one or more processors, either alone or in combination, configured to:
receive, via the one or more transceivers, a maneuver request message from a host vehicle (HV), the maneuver request message indicating a requested maneuver of the HV and driving context information of the HV, wherein the driving context information includes one or more characteristics of operating the HV;
obtain a determination result by determining whether the requested maneuver of the HV is accepted or rejected based on a planned maneuver of the RV, the requested maneuver of the HV, and the driving context information of the HV; and
transmit, via the one or more transceivers, a maneuver response message indicating the requested maneuver of the HV being accepted or rejected by the RV based on the determination result.

24. The processing device of claim 23, wherein the one or more characteristics of operating the HV comprise:
a driver's profile;
an autonomy level of the HV;
an automotive safety integrity level (ASIL) of the HV; or
any combination thereof.

25. The processing device of claim 23, wherein the determination result corresponds to:
the requested maneuver of the HV is accepted by the RV;
the requested maneuver of the HV is accepted by the RV with one or more proposed modifications;
the requested maneuver of the HV is rejected by the RV with the one or more proposed modifications; or
the requested maneuver of the HV is rejected by the RV.

26. The processing device of claim 25, wherein the one or more proposed modifications comprise:
a proposed modification to the driving context information of the HV;
a proposed modification to the requested maneuver of the HV; or
both.

27. The processing device of claim 23, wherein:
the determining whether the requested maneuver of the HV is accepted or rejected is further based on driving context information of the RV.

28. The processing device of claim 23, wherein:
the determining whether the requested maneuver of the HV is accepted or rejected is based on one or more machine learning models.

29. The processing device of claim 23, wherein the determining whether the requested maneuver of the HV is accepted or rejected comprises:
determine a maneuver safety factor associated with the requested maneuver of the HV based on kinematics of the HV, kinematics of the RV, the requested maneuver of the HV, the planned maneuver of the RV, the driving context information of the HV, driving context information of the RV, an environmental condition, one or more sensor inputs, or any combination thereof; and
determine the requested maneuver of the HV is accepted based on the maneuver safety factor being greater than a reference value.

30. A processing device of a remote vehicle (RV), comprising:
means for receiving a maneuver request message from a host vehicle (HV), the maneuver request message indicating a requested maneuver of the HV and driving context information of the HV, wherein the driving context information includes one or more characteristics of operating the HV;
means for obtaining a determination result by determining whether the requested maneuver of the HV is accepted or rejected based on a planned maneuver of the RV, the requested maneuver of the HV, and the driving context information of the HV; and
means for transmitting a maneuver response message indicating the requested maneuver of the HV being accepted or rejected by the RV based on the determination result.
